(19) United States
(12) Patent Application Publication
(10) Pub. No.: US 2007/0064119 A1
(43) Pub. Date: Mar. 22, 2007

(54) Photographing system

(75) Inventors: Yasuhiro Komiya, Tokyo (JP); Toru Wada, Niiza-shi (JP); Osamu Konno, Iruma-shi (JP); Nobumasa Sato, Ageo-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/599,013

(22) Filed: Nov. 14, 2006

Related U.S. Application Data
(63) Continuation of application No. PCT/JP05/09643, filed on May 26, 2005.

(30) Foreign Application Priority Data
May 26, 2004 (JP) 2004-156750

(51) Int. Cl. H04N 5/228

(52) U.S. Cl. 348/222.1

(57) ABSTRACT

A photographing system for photographing a subject comprises color information detecting section for detecting color information of the subject, color image capturing section for capturing a color image of the subject, and color correcting section for performing color correction of a color image captured by the color image capturing section from corresponding position information of the color information detecting section and the color image capturing section so as to enable highly accurate color correction.

### CROSS REFERENCE TO RELATED APPLICATION

This application is a continuation application of PCT/JP2005/009643 filed on May 26, 2005 and claims benefit of Japanese Application No. 2004-156750 filed in Japan on May 26, 2004, the entire contents of which are incorporated herein by this reference.

### BACKGROUND OF THE INVENTION

1. Field of the Invention

The present invention relates to a photographing system in which color correction of input images is made using spectroscopic information of a subject.

2. Description of the Related Art

Conventionally color management has been executed in many fields including industrial field, food field, medical field and the like. In the industrial field, for example, color management is carried out for the color of manufactured products, and calorimeters such as spectrometer, calorimeter are used to check if the product is finished in color within the standard. In the medical field, color management is performed for color of skin in dermatology, for example. Digital camera is often used to record change in color of skin.

With regard to digital camera, increase in the number of pixels and reduction in price have progressed recently, and fields where color management is used have been expanded with that trend. For example, use of digital cameras has begun in the dental field and the like.

Digital camera has a merit that an image of an affected area can be easily obtained and the image can be checked immediately after the image capturing but also has a problem that colors of a photographed image is different at each photographing even with the same subject since accuracy of color correction is low. The color-correction accuracy in digital camera is lowered by various factors. Particularly, drop in detection accuracy of white balance largely affects the color-correction accuracy.

Then, in Japanese Unexamined Patent Application Publication No. 2003-125422 (hereinafter referred to as Document 1), a proposal is made to improve correction accuracy of white balance. In this proposal, the correction accuracy of white balance is improved using information of calorimetric sensor at photographing by digital camera. That is, according to Document 1, a calorimetric sensor is placed in substantially the same direction as an area of photographing by the digital camera and a signal value of the digital camera is corrected on the basis of an obtained RGB value of the calorimetric sensor. In this case, the RGB value of image data photographed by the digital camera is averaged over the entire screen per RGB and compared with the colorimetric sensor.

### SUMMARY OF THE INVENTION

A photographing system according to claim 1 of the present invention is a photographing system for photographing a subject comprising color information detecting portion configured to detect color information of the subject, color image capturing portion configured to capture a color image of the subject, and a color correcting portion configured to execute color correction of color image photographed by the color image capturing portion from corresponding position information of the color information detecting portion and the color image capturing portion.

In the present invention, the color image capturing portion captures a color image of the subject and the color information detecting portion detects color information of the subject. A position in a color image of the detected color information is obtained from the corresponding position information of the color information detecting portion and the color image capturing portion, and the color image is given color-correction by the color information for this corresponding position so that a color image with color correction with high accuracy is obtained.

### BRIEF DESCRIPTION OF THE DRAWINGS

FIG. 1 is a block diagram showing a photographing system according to a first embodiment of the present invention.

FIG. 2 is an explanatory view showing an appearance when the photographing system in FIG. 1 is applied to a digital camera.

FIG. 3 is a block diagram showing a specific configuration of a digital camera 13 and a spectrometer 10 in FIG. 1.

FIG. 4 is a block diagram showing a specific configuration of a color correction portion 3 in FIG. 3.

FIG. 5 is an explanatory view showing a display example on a finder 11.

FIG. 6 is an explanatory view for explaining a relation between a camera position and a subject.

FIG. 7 is a block diagram showing another example of the color correction portion.

FIG. 8 is an explanatory view for explaining display of an image display portion 7.

FIG. 9 is a block diagram showing another example of a calorimeter.

FIG. 10 is a flowchart for explaining calculation of position information.

FIG. 11 is a block diagram showing a second embodiment of the present invention.

FIG. 12 is a block diagram showing a variation of the second embodiment.

FIG. 13 is an explanatory view showing a third embodiment of the present invention.

FIG. 14 is a block diagram showing a specific configuration of an image processing unit 202 in FIG. 13.

FIG. 15 is an explanatory view showing a variation of the third embodiment.

FIG. 16 is an explanatory view showing a variation of the third embodiment.

FIG. 17 is an explanatory view showing a fourth embodiment of the present invention.

FIG. 18 is an explanatory view showing a fifth embodiment of the present invention.

FIGS. 19A and 19B are explanatory views showing the configuration of a color separation filter 230.

FIGS. 20A to 20C are graphs for explaining the characteristic of a photographing band.

FIG. 21 is a block diagram showing circuit configuration inside a digital camera 229.

FIGS. 22A and 22B are explanatory views for explaining a corresponding position.

FIG. 23 is a block diagram showing a specific configuration of a color correction portion 244 in FIG. 21.

FIG. 24 is an explanatory view showing a wavelength variable filter 237 using liquid crystal or the like.

FIG. 25 is a block diagram showing a sixth embodiment of the present invention.

FIG. 26 is an explanatory view showing the configuration of a spectral filter 54 in FIG. 25.

FIG. 27 is an explanatory view for explaining an operation dial 8.

FIG. 28 is an explanatory view showing an example that photographing directions, field angels of a digital camera 245 and a multiband camera 50 are matched with each other.

FIG. 29 is an explanatory view for explaining camera-shake correction.

FIG. 30 is a block diagram showing the configuration of a displacement correction portion.

FIG. 31 is a block diagram showing a seventh embodiment of the present invention.

FIG. 32 is a block diagram showing a specific circuit configuration of an image processing portion.

FIG. 33 is a block diagram showing a specific configuration of a corresponding position calculation portion 107 in FIG. 32.

FIGS. 34A and 34B are explanatory views showing in input image of the corresponding position calculation portion 107.

FIGS. 35A to 35C are explanatory views for explaining each photographing mode.

FIG. 36 is an explanatory view for explaining an action of the embodiment.

FIG. 37 is a block diagram showing another applied example using an image processing portion 269 using a calorimetric image as an image processing portion.

FIG. 38 is an explanatory view showing an eighth embodiment of the present invention.

### DETAILED DESCRIPTION OF THE PREFERRED EMBODIMENTS

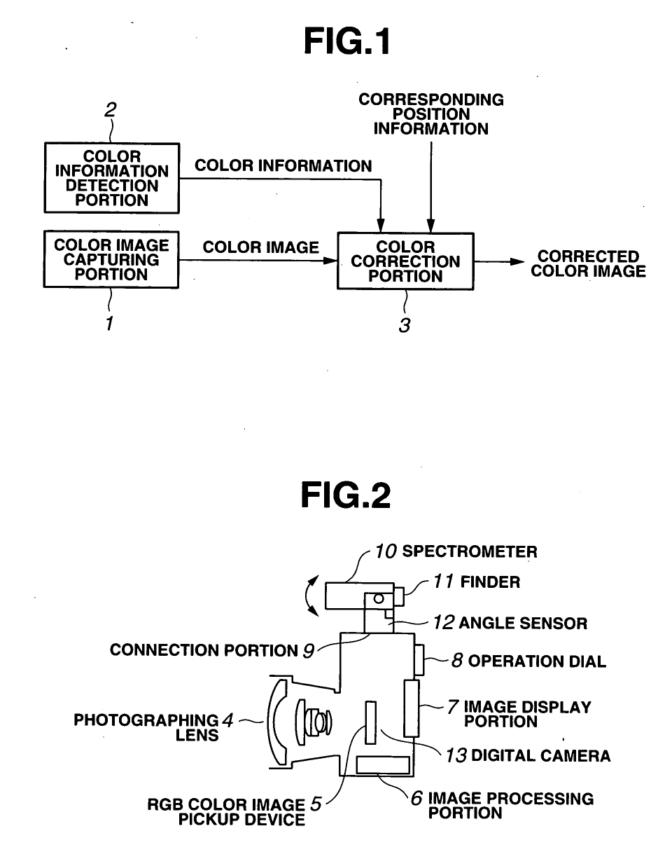

Embodiments of the present invention will be described below in detail referring to the attached drawings. FIG. 1 is a block diagram showing a photographing system according to a first embodiment of the present invention.

In FIG. 1, the photographing system has a color image capturing portion 1 and a color information detection portion 2. The color image capturing portion 1 comprises a digital camera or the like, for example, and captures an image of a subject, not shown, and outputs a color image of an RGB three-primary-color image or the like, for example, to a color correction portion 3.

The color information detection portion 2 detects color information at a predetermined position of a part of the subject photographed by the color image photographing portion 1 and outputs the detected color information to the color correction portion 3. To the color correction portion 3, a corresponding position information on a position in the color image from the color image photographing portion 1 to which the color information detected by the color information detection portion 2 corresponds is inputted.

The color correction portion 3 corrects the information of the corresponding position in the color image on the basis of the corresponding position information and outputs it as a corrected color image.

FIG. 2 is an explanatory view showing an appearance when the photographing system in FIG. 1 is applied to a digital camera.

In this embodiment, a digital camera 13 by which RGB information as information of a color image can be obtained is employed. To this digital camera 13, a spectrometer as a calorimeter for detecting spectrum as color information (hereinafter referred to as a calorimeter) 10 is mounted. FIG. 2 shows only major components of the digital camera. That is, the digital camera 13 comprises a photographing lens 4, an RGB color image pickup device 5, an image processing portion 6, an image display portion 7, and an operation dial 8. Also, to an enclosure of the digital camera 13, a connection portion 9 is provided to which the spectrometer 10 is mounted, and the spectrometer 10 is mounted by this connection portion 9 as a usual electronic flash. The spectrometer 10 mainly comprises a finder 11 and an angle sensor 12.

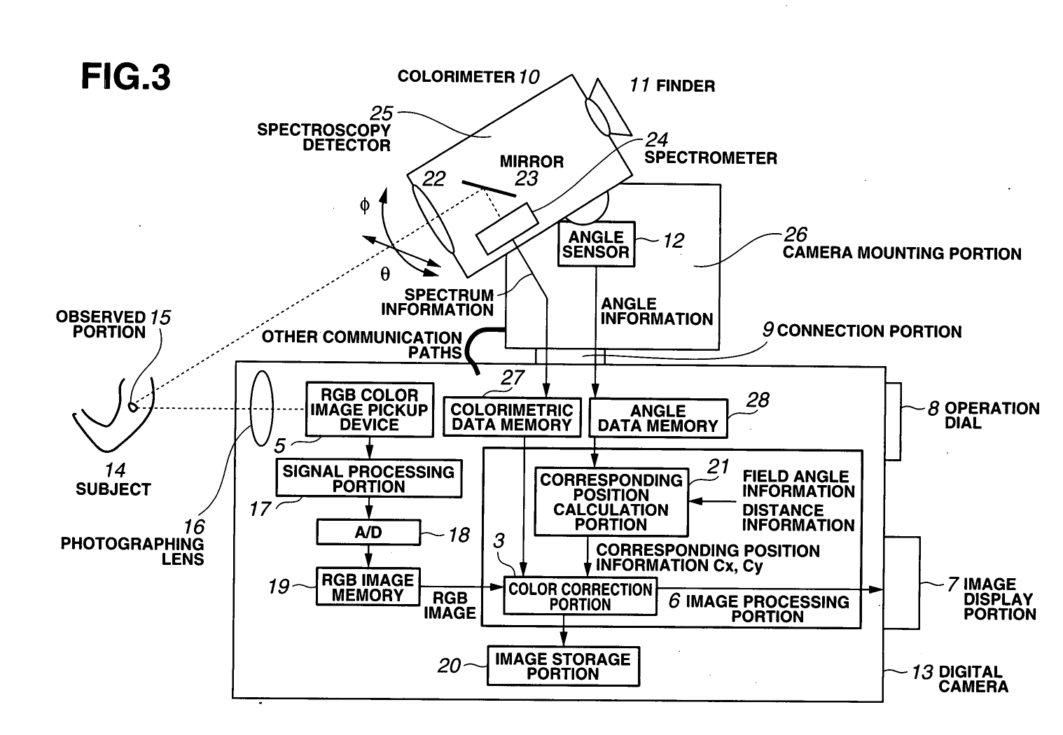

FIG. 3 is a block diagram showing a specific configuration of the digital camera 13 and the spectrometer 10 in FIG. 1

Reference numeral 14 denotes a subject to be photographed and FIG. 3 shows an example that the subject 14 is an arm of a man. Reference numeral 15 denotes an observed portion and an affected portion in the arm (irritation or the like), for example. The digital camera 13 has an image of the subject formed on the RGB color image pickup device 5 by a photographing lens 16. A signal processing portion 17 is an analog processing circuit for performing gain correction, offset correction and the like. Reference numeral 18 is an AD converter, and reference numeral 19 is an RGB image memory, which is a memory portion of an RGB image.

The calorimeter 10 comprises a spectroscopy detection portion 25 and a camera mounting portion 26, and the spectroscopy detection portion 25 is rotated vertically and horizontally with respect to the camera mounting portion 26. Reference numeral 22 denotes a photographing lens of the spectrometer 10, and a light flux of the subject 14 is sent to the spectrometer 24 and the finder 11 through a half mirror 23. The angle sensor 12 detects an angle of rotation of the spectroscopy detection portion 25 and outputs angle information. The spectrometer 24 spectro-analyzes an incident light from the half mirror 23 and outputs spectral information.

The angle information from the angle sensor 12 and the spectrum information from the spectrometer 24 are given to and stored in an angle data memory 28 or a calorimetric data memory 27, respectively, within the digital camera 13.

The corresponding position detection portion 21 in the image processing portion 6 of the digital camera 13 calculates at what position in the photographed RGB image a measured position on the subject of the colorimeter 10 is located on the basis of the angle information obtained from the angle sensor 12, field angle information of the photographing lens 16 and distance information to the subject. The corresponding position information is given to the color correction portion 3 as two-dimensional coordinate information Cx, Cy. Reference numeral 20 denotes an image storage portion and reference numeral 7 denotes an image display portion for storage and display, respectively, of the RGB image corrected by the color correction portion 3.

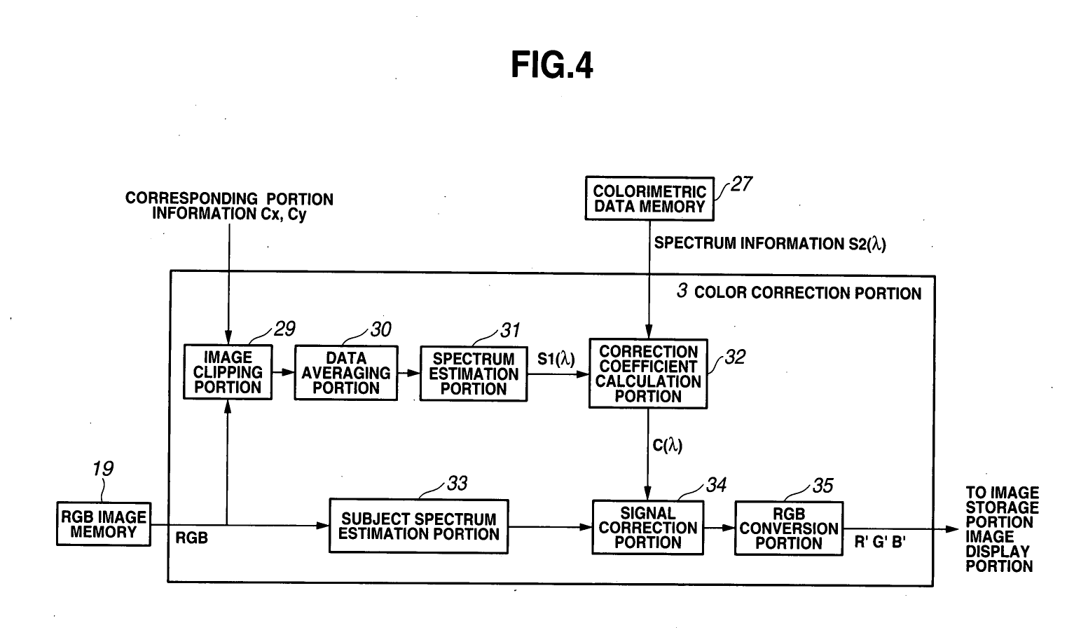

FIG. 4 is a block diagram showing a specific configuration of the color correction portion 3 in FIG. 3.

Reference numeral 29 denotes an image clipping portion for clipping an image on the basis of the corresponding position information Cx, Cy from the RGB image memory 19, reference numeral 30 is a data averaging portion for acquiring an average of clipped data, reference numeral 31 is a spectrum estimation portion for making spectrum estimation from the averaged data, and reference numeral 32 is a correction coefficient calculation portion for calculating a correction coefficient C (λ). Reference numeral 33 is a subject spectrum estimation portion for estimating spectrum at each position of the subject 14 on the basis of the RGB signal stored in the RGB image memory 19, and reference numeral 34 is a signal correction portion. Reference numeral 35 denotes an RGB conversion portion for converting the spectroscopic signal to RGB.

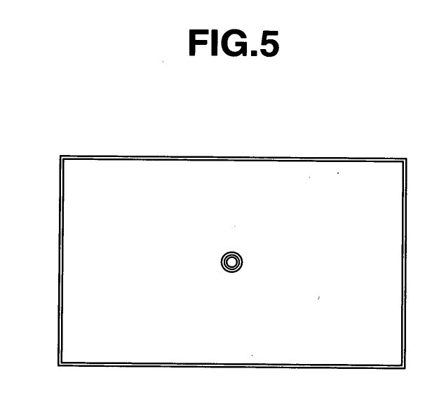

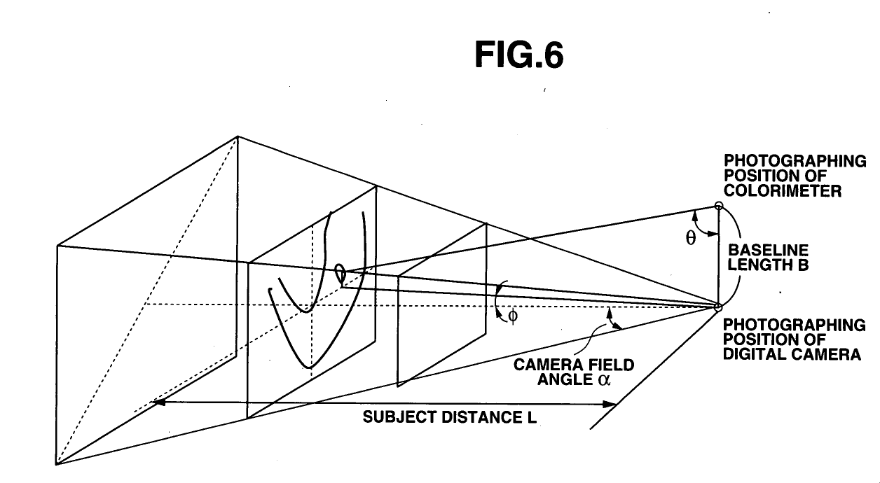

Next, action of the so configured embodiment will be described referring to FIGS. 5 and 6. In this embodiment, photographing at a dermatologist will be described as an example. FIG. 5 is an explanatory view showing a display example of the finder 11. FIG. 6 is an explanatory view for explaining a relation between a camera position and the subject.

First, at photographing, the digital camera 13 is placed on a camera fixing device, not shown, such as a tripod stand. A patient is seated on a chair or the like and places the affected area (a part of an arm in this case) on a desk or the like opposite to the shooting direction of the digital camera 13 so that it is not moved but fixed.

An operator such as a doctor, a nurse or the like adjusts framing of the subject 14 to be photographed by operating a zoom or a handle of the tripod stand, not shown, of the digital camera 13. For example, suppose that the entire arm including the affected area is to be photographed. In this case, the affected area is not necessarily located at the center of the screen of the digital camera 13. When framing is determined, the affected area is located at the central position of the screen while watching the finder 11 of the calorimeter 10.

The state is seen on the finder 11 as FIG. 5, and by aligning the circular portion at the center with the affected area, the measuring direction of the calorimeter 10 can be accurately opposed to the subject 14. When photographing preparation in the digital camera 13 and the colorimeter 10 is completed in this way, photographing takes place, and image data of the photographed subject image is stored in the RGB image memory 19 or spectrum data in the colorimetric data memory 27.

The relation between the camera position and the subject 14 at photographing is as shown in FIG. 6. That is, from a field angle a of the digital camera 13, distance information L to the subject 14 converted from AF information, angles θ, ø of the calorimeter, and base-line length B of the digital camera 13 and the colorimeter 10, the position of an observed subject (image at the observed portion 15) on the RGB image can be calculated. At the corresponding position calculation portion 21, the corresponding position is calculated as the two-dimensional coordinate values Cx, Cy by arithmetic operation and outputs the value to the color correction portion 3.

The color correction portion 3 clips a rectangular area with the corresponding position of the subject image stored in the RGB image memory 19 at the center on the basis of the calculated two-dimensional coordinate values Cx, Cy. The size of the rectangular area is 16×16 pixels, for example. For an image signal of this rectangular area, average values (Rave, Gave, Bave) of all the pixels are acquired by the data averaging portion 30. The spectrum estimation portion 31 estimates a spectroscopic signal S1 (λ) by a method disclosed in Japanese Unexamined Patent Application Publication No. 11-085952, for example, form these average values (Rave, Gave, Bave). Next, at the correction coefficient calculation portion 32 calculates the correction coefficient C (λ) using the spectrum information S2 (λ) stored in the colorimetric data memory 27 according to the following equation (1):
C(λ)=S2(λ)/S1(λ) (1)

On the other hand, image data is sequentially read out of the RGB image memory 19 for each pixel and sequentially converted to a spectroscopic signal at the subject spectrum estimation portion 33. And it is multiplied by the correction coefficient C(λ) calculated at the correction coefficient calculation portion 32 at the signal correction portion 34 and the signal value is corrected. The corrected spectroscopic signal value is converted to an RGB value at the RGB conversion portion 35, and a corrected R′G′B′ signal is outputted as a corrected color image. This corrected R′G′B′ signal is sent to the image storage portion 20, the image display portion 7, for example.

According to this embodiment, in this way, since the photographed RGB image is corrected on the basis of the spectrum data obtained by separately provided colorimeter, color correction with an extremely high accuracy is possible. Also, in calculation of a correction coefficient, since a predetermined area of the RGB image accurately corresponding to the measurement position of the colorimeter is detected, the correction coefficient accuracy is extremely high.

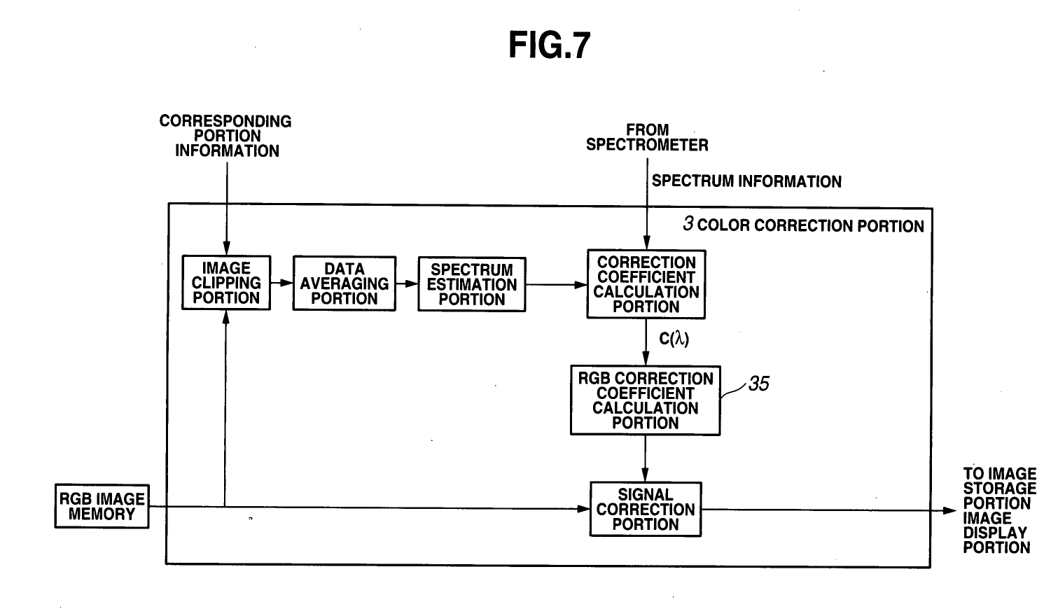

In this embodiment, conversion to spectral data is carried out once in correction of the RGB image, but in order to reduce calculation quantity, as shown in FIG. 7, an RGB correction coefficient calculation portion 35 is newly provided so as to obtain a correction coefficient corresponding to the spectrum as a coefficient corresponding to an RGB signal and this coefficient may be multiplied by the RGB image data. In this case, the subject spectrum estimation portion, the RGB conversion portion are not needed any more, and it is possible to considerably reduce the calculation quantity.

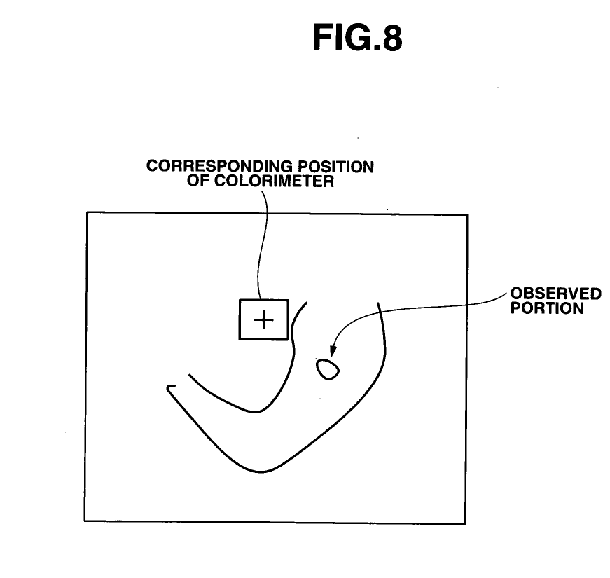

Also, as shown in FIG. 8, the corresponding position of the calorimetric system is superimposed and displayed by a cross mark or the like in the image display portion 7 of the digital cameral. This mark position is displayed on the basis of Cx, Cy obtained at the corresponding position calculation portion 21. The operator can align the mark position to the affected portion, which is the observed portion 15 at photographing by moving the colorimeter 10 vertically and horizontally while watching this mark. Since the corresponding position can be checked on the screen, the corresponding position can be aligned accurately.

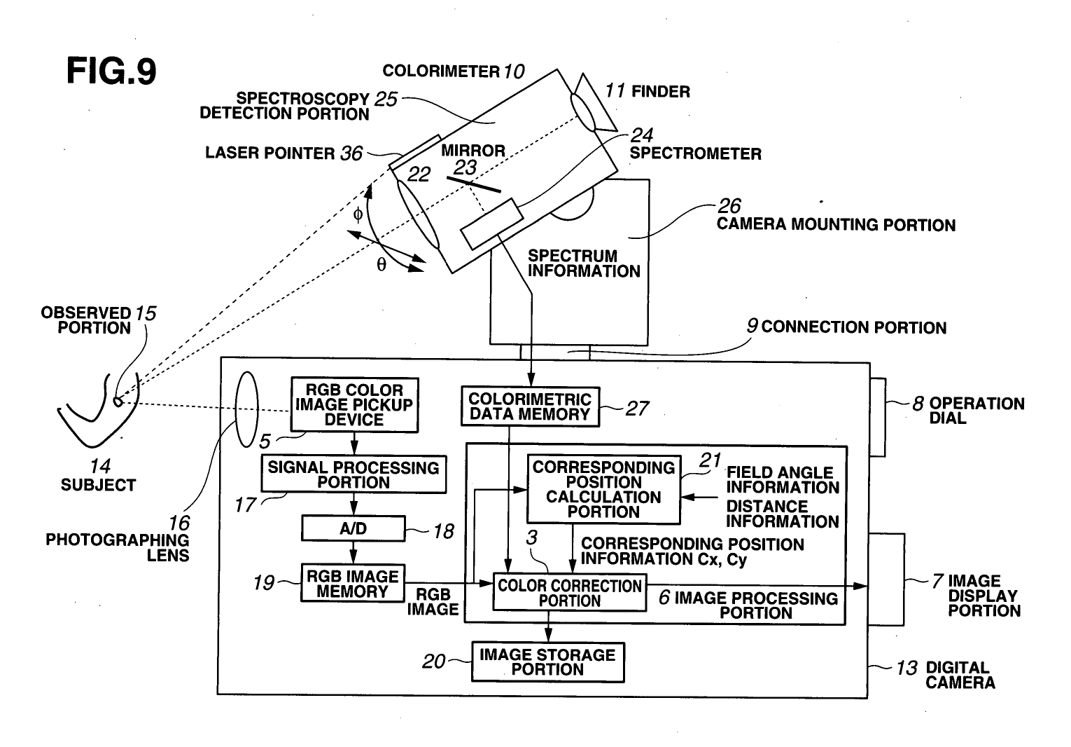

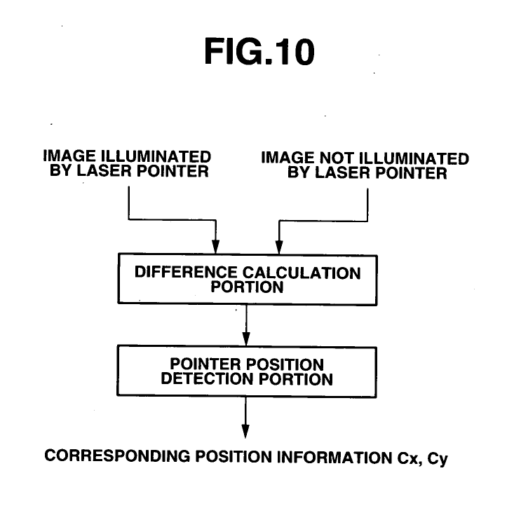

Also, as shown in FIG. 9, it may be so configured that a laser pointer 36 is provided at the colorimeter 10 so as to obtain the corresponding position. In this case, at alignment of the colorimeter 10, the colorimetric point of the calorimeter 10 is aligned to the affected portion (observed portion 15) of the subject in the finder 11 as above. And at photographing by the digital camera 13, light is emitted from the laser pointer 36, and an image on which the laser pointer 36 appears is shot. Then, an image on which the laser pointer 36 is not illuminated is captured. At the corresponding position calculation portion 21, a difference between the image on which the laser pointer 36 is illuminated and the image on which is it not illuminated is detected as in FIG. 10, and the corresponding position is calculated using a point with larger difference value.

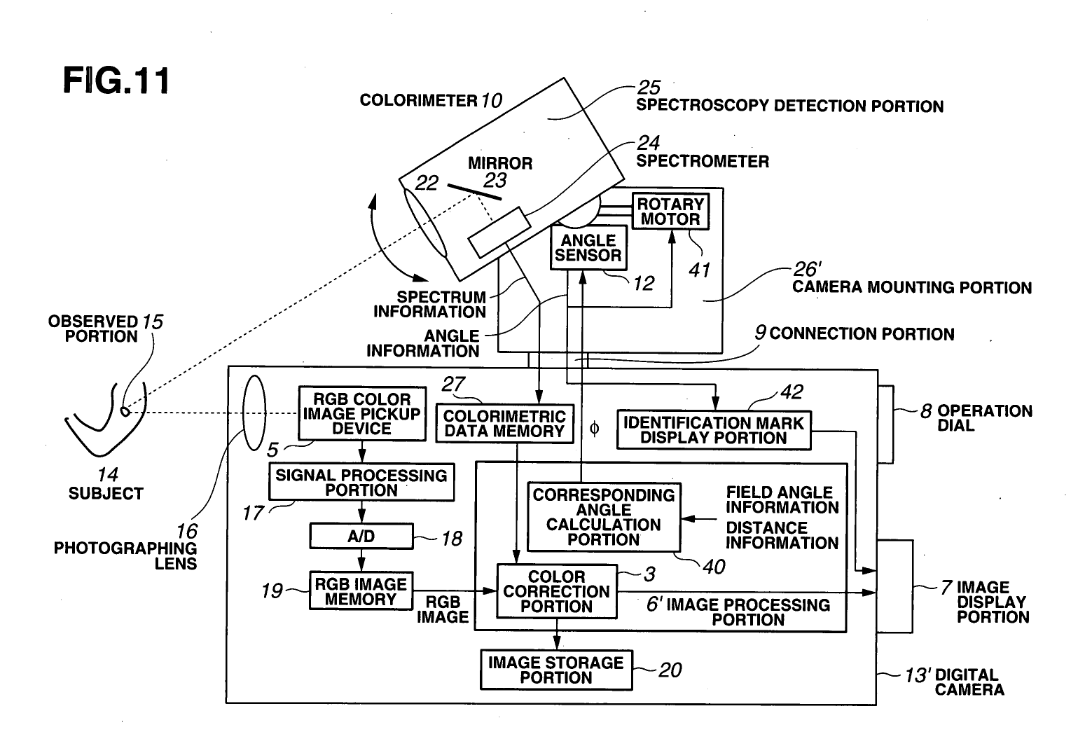

FIG. 11 relates to a second embodiment of the present invention and is a block diagram showing a specific configuration of a digital camera 13′ and the spectrometer 10. In FIG. 11, the same reference numerals are given to the same components as those in FIG. 3 and the description will be omitted.

In the first embodiment, the calorimeter is moved vertically and horizontally and the angles θ, ø are detected so as to detect the corresponding position with the RGB image, but in this embodiment, the photographing direction of the colorimeter is controlled to a position aimed at by the digital camera.

As shown in FIG. 11, this embodiment is different from the first embodiment and a corresponding angle calculation portion 40 and a rotary motor 41 are provided. The spectroscopy detection portion 25 is configured so that it can move only vertically with respect to the camera mounting portion 26′. In the digital camera 13′, the observed portion 15 is captured at the center of the image capturing range of the camera all the time. And it is so configured that at the corresponding angle calculation portion 40, an angle to capture the observed portion 15 is calculated by the spectroscopy detection portion 25 from the distance information to the subject 14 and the field angle information of the camera, and the rotary motor 41 is controlled to have this angle.

In the embodiment configured as above, at photographing, the digital camera 13′ is first substantially opposed to the subject 1 and the camera position is adjusted so that the affected portion (observed portion 15) of the subject 14 is located at the center of the photographing screen. After that, when a shutter button, not shown, is pressed halfway, AF operation is performed and the distance to the subject 14 is measured. The corresponding angle calculation portion 40 calculates the angle ø that the photographing direction of the calorimeter 10 is directed to the observed portion 15 (affected portion) of the subject 14 on the basis of this information. And the spectroscopy detection portion 25 is rotated by the rotary motor 41 using the information of the angle sensor 12 and it is stopped at the position where the angle becomes this angle ø. The information that the angle becomes the predetermined angle is transmitted to the digital camera 13′ side, and a mark or the like showing that photographing is available is displayed at the image display portion 7. After checking the display of this mark, the operator fully presses the shutter button to perform photographing. In this way, the RGB image and the spectral data at substantially the same time are recorded. The processing after that is substantially the same as that of the first embodiment, but as the corresponding position information used at the image clipping portion 29, a value showing the coordinate of the center of the screen is given.

In this embodiment, since the direction of the calorimeter is automatically changed by the information of the photographing distance, there is no need for the operator to align the colorimeter but photographing can be performed extremely easily. Also, since the photographing is performed after display on whether the direction of the calorimeter has been changed or not on the image display portion and check of it, the relation between the RGB image and the photographing range of the colorimeter can be accurately specified.

Though a specific mark is displayed in the image display portion for this check, it may be transmitted by sound or lighting of a lamp such as LED. Also, in the case of photographing of an affected area displaced from the center of the screen using a focus lock of the digital camera and the like, a rotating angle of the camera may be detected and the calorimeter is rotated horizontally.

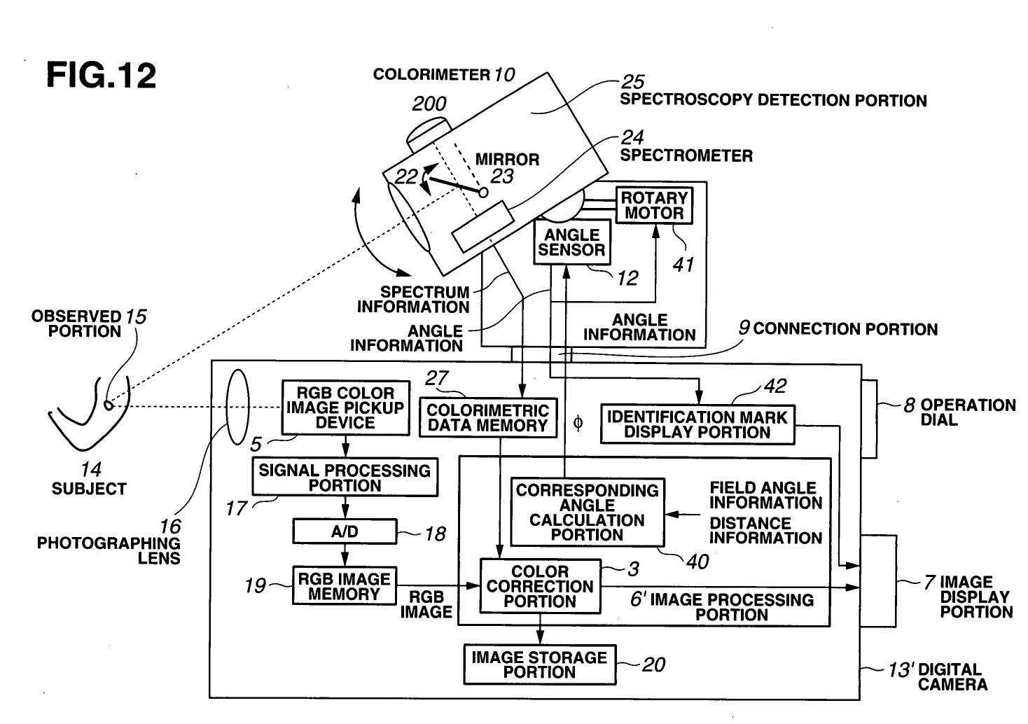

FIG. 12 shows a variation of this embodiment. A mirror 23 of the calorimeter 10 is configured to be rotated and it can be moved to a position shown by a dotted line. When the mirror 23 is moved to this dotted-line position, a light flux enters the colorimeter 10 from a white board 200, and illumination spectrum in the vicinity of the digital camera 3′ can be detected. Using the detected illumination spectrum information in this way, accurate color information of the subject 14 can be detected. For a detailed detecting method, the method disclosed in Japanese Unexamined Patent Application Publication No. 11-085952 may be employed. At photographing, the spectrum information of the observed portion 15 and the illumination spectrum in the vicinity of the digital camera 3′ are measured along with the information of the digital camera 13′, and accurate colors of the observed portion 15 are estimated on the basis of the information.

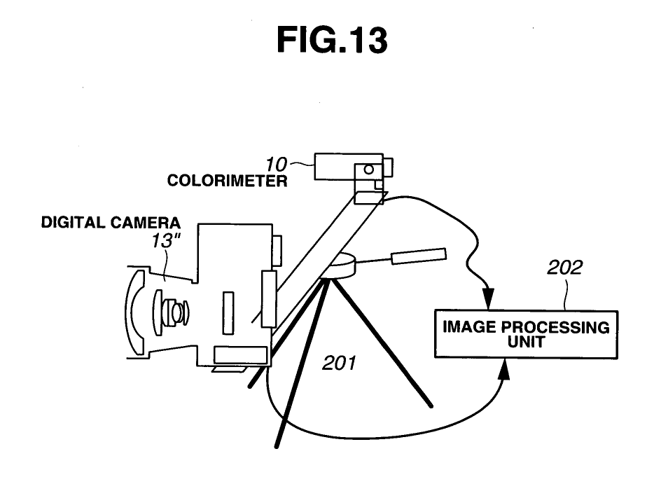

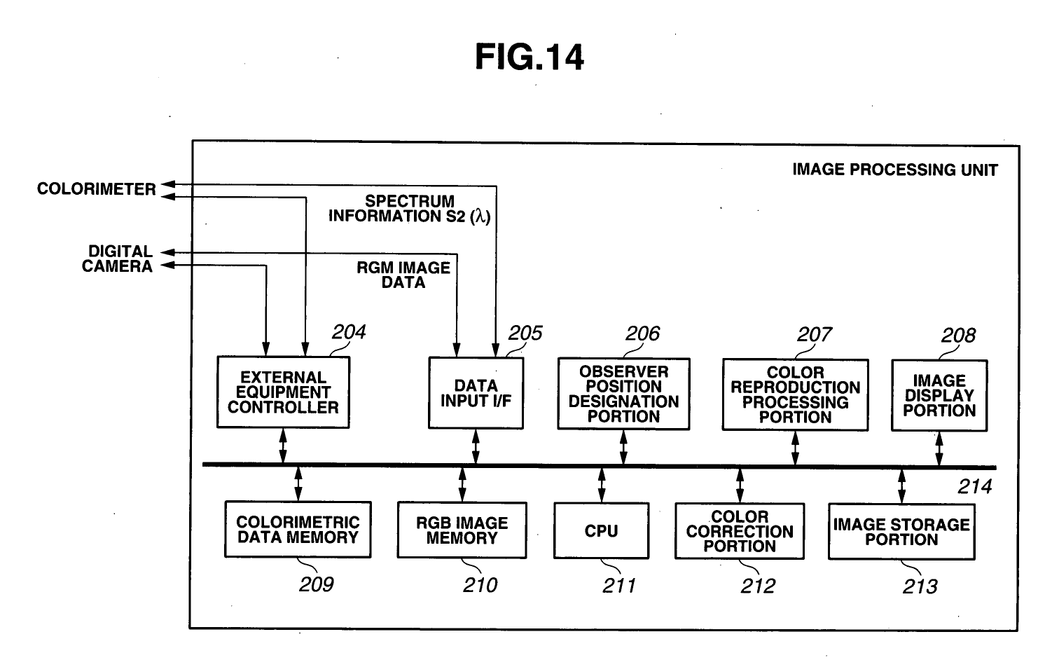

FIGS. 13 and 14 relate to a third embodiment of the present invention, and FIG. 13 is an explanatory view showing an appearance of the device. This embodiment shows an example that a colorimeter and a digital camera are mounted to a tripod stand or the like to constitute them separately.

In FIG. 13, reference numeral 201 is a tripod stand to which both the colorimeter 10 and the digital camera 13″ can be mounted. The colorimeter 10 and the digital camera 13″ are connected to an image processing unit 202, respectively. The image processing unit 202 is a control device comprised by a personal computer or the like.

FIG. 14 is a block diagram showing a specific configuration of the image processing unit 202 in FIG. 13

In FIG. 14, reference numeral 204 denotes an external equipment controller and a controller such as a USB, RS-232C, for example. Reference numeral 205 is a data input I/F to which spectrum information is inputted from the calorimeter 10 and the RGB image data is inputted from the digital camera 13″. The spectrum information and RGB image data taken in the data input I/F 205 are given and stored in a colorimetric data memory 209 or an RGB image memory 210, respectively.

An observed position designation portion 206 designates at which position on the RGB screen a calorimetric point of the colorimeter 10 is located. A color correction portion 212 corrects color of the RGB image data based on the spectrum information. A color reproduction processing portion 207 further corrects color of the RGB image color-corrected at the color correction portion 212 using profile information of an image display portion 208. An image storage portion 213 stores the RGB image data corrected by the color correction portion 212 and the color reproduction portion 207. A CPU 211 is to control the entire image processing unit 202.

In the embodiment configured as above, first, photographing of the digital camera 13″ is executed by control of the image processing unit 202, and then, color measurement is carried out by the colorimeter 10. The RGB image data from the digital camera 13″ and the spectrum information from the calorimeter 10 are stored in the RGB image memory 210 or the colorimetric data memory 209, respectively.

At the observed position designation portion 206, the shot RGB image is displayed on the image display portion 208. The operator designates the calorimetric point by the colorimeter 10 using a screen position designating device, not shown, such as a mouse while observing the display by the image display portion 208. Corresponding position information Cx, Cy on the basis of the angle information, the field angle information from the colorimeter 10 and the digital camera 13″ as well as the distance information to the subject and the like are given to the color correction portion 212 (not shown). The color correction portion 212 corrects color of the RGB image data on the basis of an output of the colorimeter 10 for the area based on the corresponding position information in the RGB image.

In this embodiment, in this way, those of commercially available can be used for both the digital camera 13″ and the calorimeter 10, and color correction with high accuracy is possible easily with a simple configuration.

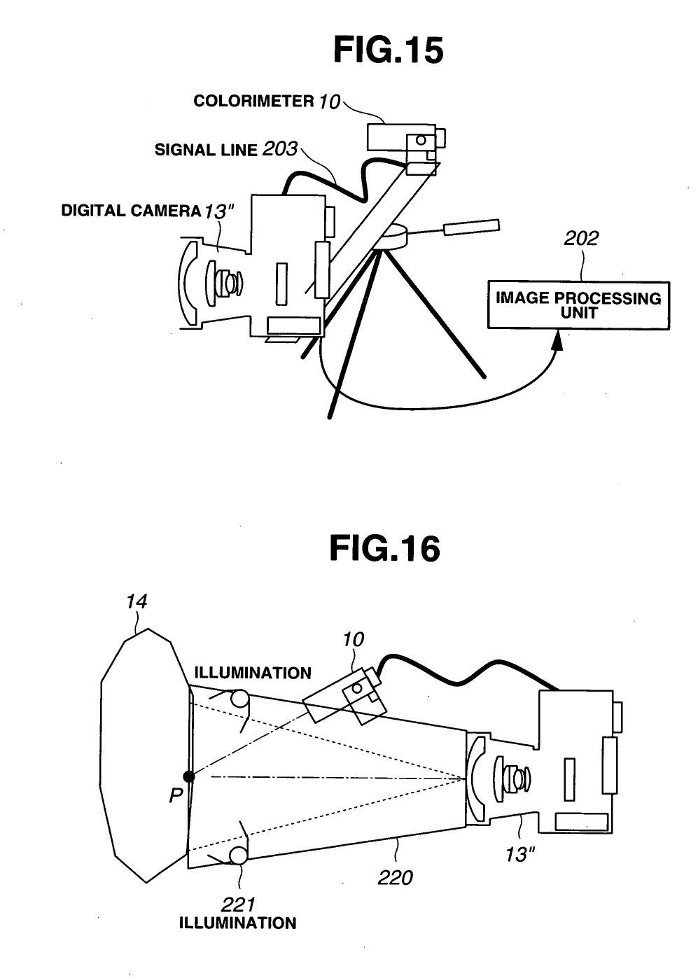

By having the digital camera 13″ and the colorimeter 10 connected by a signal line 203 to make communication available as shown in FIG. 15, it is also possible to perform photographing by the digital camera 13″ and color measurement by the colorimeter 10 at the same time and to supply the data of the colorimeter 10 to the image processing unit 202 through the digital camera 13″, which reduces the number of signal lines and can simplify the system.

FIG. 16 shows a variation of the third embodiment. The variation in FIG. 16 is configured so that a hood with illumination 220 is mounted to the digital camera 13″. The hood with illumination 220 is configured so that an illuminating device 221 is incorporated and the colorimeter 10 can be mounted fixedly. At photographing, the tip end of the hood 220 is brought into contact with the subject 14 to be photographed, and the colorimetric point of the colorimeter 10 is also set to the position of a point P at the shooting center of the digital camera 13″.

According to this configuration, the center position of the photographing screen of the digital camera 13″ can be color-measured by the colorimeter 10 easily only by pressing the exclusive hood 220 into contact with the subject 14. By this, the corresponding position can be set fixedly all the time, and photographing can be made extremely easily and stably.

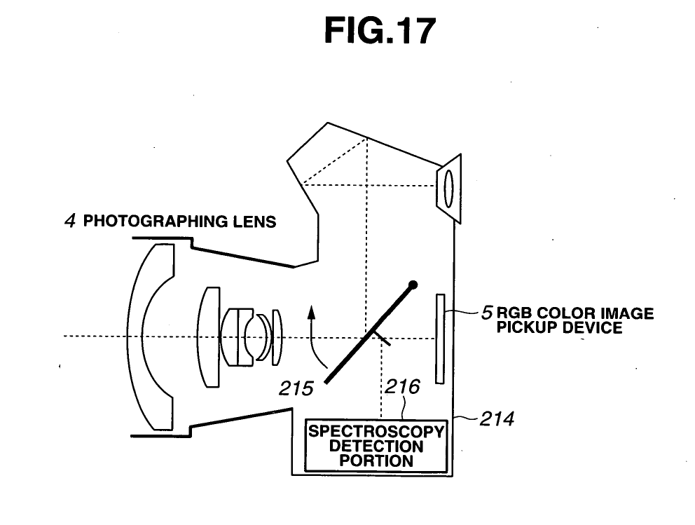

FIG. 17 is an explanatory view showing a fourth embodiment. The form of this embodiment is not configured by a digital camera and a colorimeter separately but a photographing system provided with a colorimeter portion inside the digital camera.

As shown in FIG. 17, in the digital camera 214 in this embodiment, a half mirror 215 and a spectroscopy detection portion 216 are provided. The half mirror 215 guides a part of a light flux of the subject (central subject on the screen of the digital camera), not shown, on the optical axis to the spectroscopy detection portion 216. At photographing by the RGB color image pickup device 5, the half mirror 215 is rotated in the direction of an arrow in FIG. 17 to guide the light flux of the subject to the RGB color image pickup device 5.

In this embodiment configured as above, when a shutter button, not shown, is pressed halfway, first, the focus is adjusted to the center position on the screen and then, by action of the spectroscopy detection portion 216, spectrum of the subject at the center of the screen is measured. Then, when the shutter button is fully pressed, the mirror 215 is rotationally moved, the light flux of the subject is made to enter the RGB color image pickup device 5, and an RGB image is captured. The other processing is the same as that of the first embodiment.

In this embodiment, in this way, since the spectroscopy detection portion 216 is provided inside the camera and it is not constituted separately as each of the above embodiments but the same optical system and image pickup device are used, usability is extremely high. Also, since the center position on the screen is set as a calorimetric point all the time, detection of a corresponding position will never fail but stable colorimetry is possible.

In this embodiment, the spectroscopy detection portion 216 detects only the point of optical axis but it is obvious that a plurality of spectroscopy detection portions 216, for example, may provided in correspondence to a plurality of focus detection positions and used by switching according to the focus position.

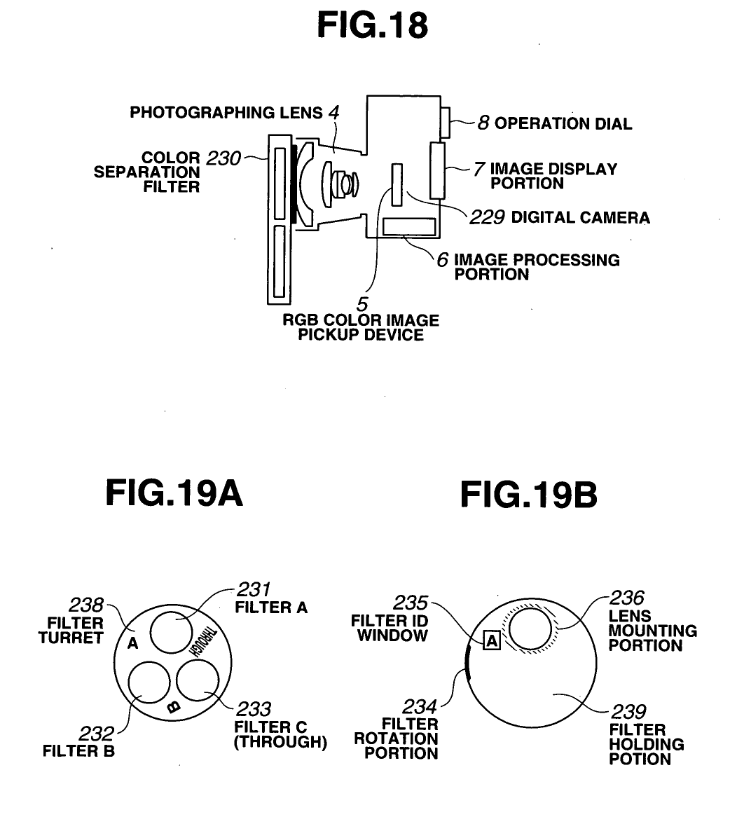

FIGS. 18 to 23 relate to a fifth embodiment and FIG. 18 is an explanatory view showing an appearance of the device. In this embodiment, instead of a calorimeter, an example using a multiband camera will be described.

In this embodiment, as shown in FIG. 18, a color separation filter 230 for multiband photographing is provided immediately before a usual digital camera 229. FIGS. 19A and 19B are explanatory views showing the configuration of the color separation filter 230. The color separation filter 230 comprises a filter turret 238 having a filter A, a filter B and a filter C, and a filter holding portion 239. The filter turret 238 is held in the filter holding portion 239 capable of rotational movement. FIG. 19A shows the filter turret 238 constituting the color separation filter 230 and FIG. 19B shows the filter holding portion 239 constituting the color separation filter 230.

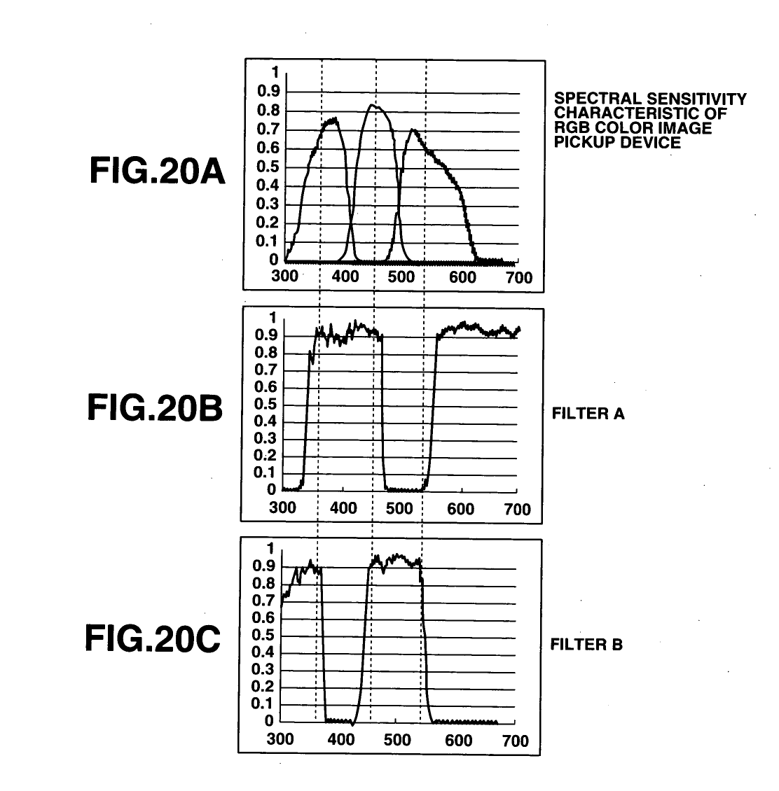

FIGS. 20A to 20C are graphs for explaining the characteristics of a photographing band, and FIG. 20A is a graph showing a spectral sensitivity characteristic of the RGB color image pickup device 5, FIGS. 20B and 20C are graphs showing the characteristics of the filters A, B, respectively of the color separation filter 230.

The spectral transmission characteristics of the filters A, B are, as shown in FIGS. 20B and 20C, such that the respective peak positions of the spectral sensitivity of the RGB color image pickup device 5 shown in FIG. 20A are held by each, and by switching between the filter A and the filter B for photographing, 6-band photographing is made possible. Also, the filter C is a through filter and enables usual RGB photographing. For the filters A, B, not only an interference filter but a wavelength variable filter can be employed.

Moreover, this filter holding portion 239 has a filter rotation portion 234 and can directly rotate the filter turret 238 manually. Also, the filter holding portion 239 can be directly mounted to the photographing lens 4 of the digital camera 229 by a lens mounting portion 236. A filter ID window 235 is provided at the filter holding portion 239 so that the type of the filter arranged immediately before the photographing lens 4 at present can be visually checked.

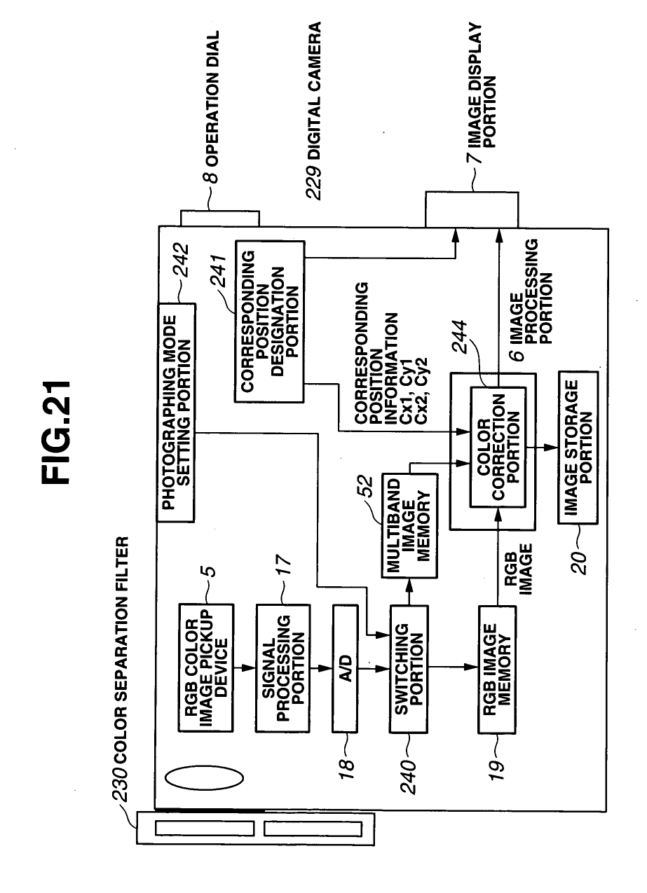

FIG. 21 is a block diagram showing a circuit configuration inside the digital camera 229. In FIG. 21, the same components as those in FIG. 3 are given the same reference numerals and the description will be omitted.

In FIG. 21, reference numeral 52 is a multiband image memory, and an RGB image captured by the filter A, the filter B is stored as a multiband image of 6 bands. Reference numeral 240 denotes a switching portion for switching the destination of storage of the multiband image and the RGB image, and switching is carried out according to a designated mode of a photographing mode switching portion 242.

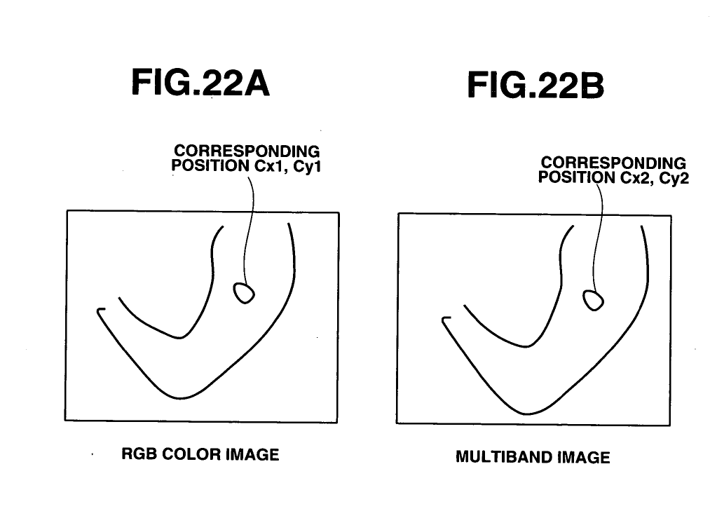

The photographing mode shall be two types of an “RGB mode” and a “multiband mode”. Reference numeral 241 is a corresponding position designation portion for designating a subject position in the RGB image and the subject position in the multiband image. In the case of this embodiment, since the multiband image is formed by two types of RGB images, each RGB image is sequentially displayed on the image display portion 7 (6 images in total), and the position corresponding to the RGB image is designated by the operation dial 8. FIGS. 22A and 22B are explanatory views for explaining the corresponding position, and FIG. 22A shows an RGB image, while FIG. 22B shows a multiband image.

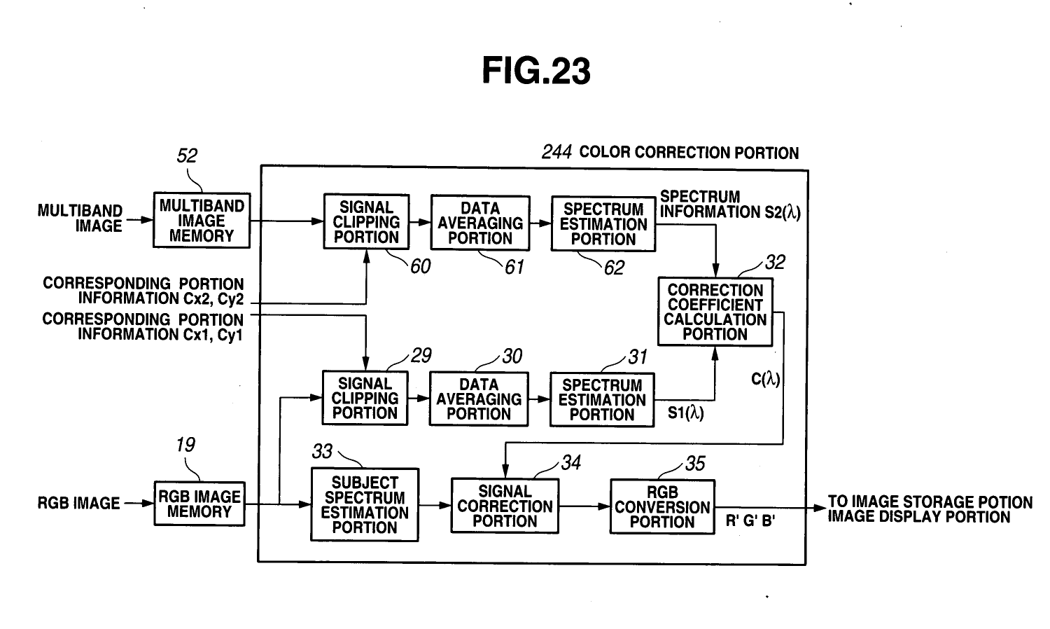

FIG. 23 is a block diagram showing a specific configuration of a color correction portion 244 in FIG. 21. The color correction portion 244 is different from the above embodiments in the point that two systems of signal clipping portions 29, 60, data average portions 30, 61, and spectrum estimation portions 31, 62 are provided. By this configuration, the color correction portion 244 detects spectrum of the corresponding position of the multiband image to carry out color correction.

In this embodiment configured as above, the “multiband mode” is designated first at photographing, and an image is captured by setting the filter A. Then, the filter B is set manually for photographing. The images captured by the filters A, B are stored in the multiband image memory 52 (FIG. 23). Next, the “RGB mode” is designated, and the filter C is selected for photographing, and the captured image data is stored in the RGB image memory 19.

The color correction portion 244 receives the multiband image inputted from the multiband image memory 52, and at the signal clipping portion 60, the data averaging portion 61 and the spectrum estimation portion 62, spectrum information S2 (λ) at the position corresponding to the corresponding position information Cx2, Cy2 is obtained. Also, the color correction portion 244 receives the RGB color image inputted from the RGB image memory 19 and at the signal clipping portion 29, the data averaging portion 30 and the spectrum estimation portion 31, spectrum information at the position corresponding to the corresponding position information Cx1, Cy1 is obtained.

The correction coefficient calculation portion 32 calculates a correction coefficient C(λ) on the basis of the above quotation (1). The subsequent operation is the same as that of the first embodiment.

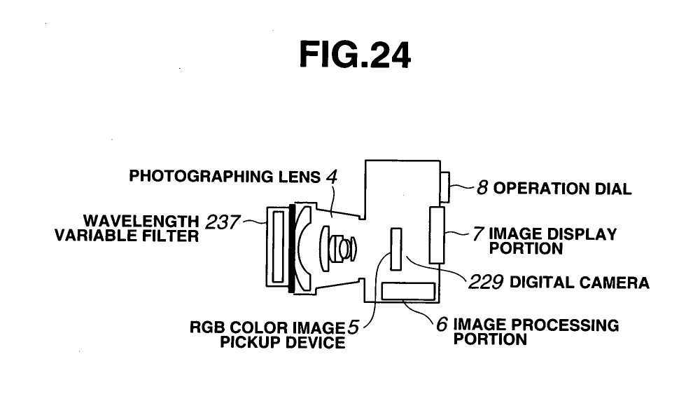

In this embodiment, in this way, by using the color separation filter capable of manual rotation, color correction of an RGB image can be carried out extremely inexpensively. Also, since the corresponding position of the image captured by the color separation filter is designated manually using the operation dial, even if the camera is moved at shooting by the filter A, B, C due to camera shake or the like, the corresponding position can be accurately designated. It is obvious that a wavelength variable filter 237 using a liquid crystal or the like as in FIG. 24 may be used instead of the color separation filter.

Also, in this embodiment, operation of the color separation filter 230 is totally manual and communication with the digital camera 229 side is not executed at all, but filter rotation operation, filter ID detection may be performed by instruction from the digital camera 229 side. It is needless to say that a photographing lens integral with such a filter may be used.

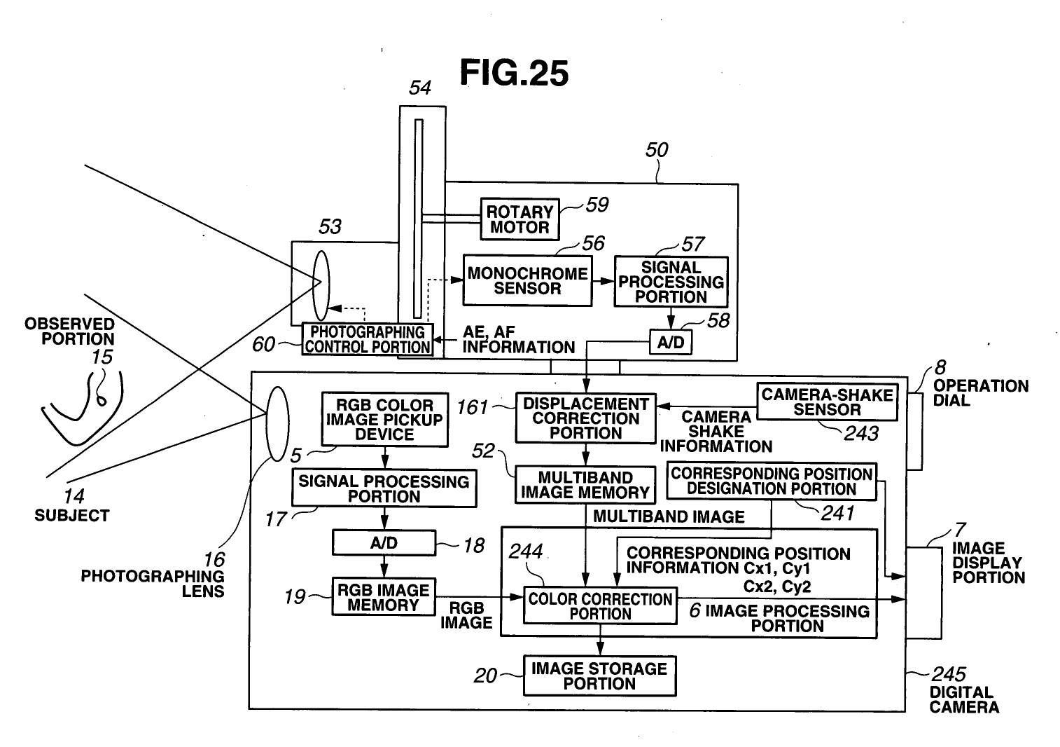

FIGS. 25 to 30 relate to a sixth embodiment of the present invention, and FIG. 25 is a block diagram showing a specific configuration. In this embodiment, too, an example is shown using a multiband camera. In FIG. 25, the same components as those in FIG. 21 are given the same reference numerals and the description will be omitted.

In this embodiment, a multiband camera 50 is provided on the digital camera 245. The multiband camera 50 comprises a photographing lens 53, a spectral filter 54, a rotary motor 59, a monochrome sensor 55, a signal processing portion 57 and an A/D converter 58.

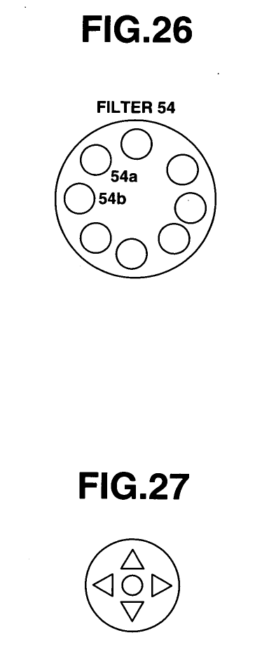

FIG. 26 is an explanatory view showing the configuration of the spectral filter 54 in FIG. 25. The spectral filter 54 comprises, as shown in FIG. 26, a plurality of color filters 54a, 54b having mutually different spectral transmission characteristics. An example in FIG. 26 has 8 filters but the number of filters is not limited to 8. A photographing control portion 60 controls focus, diaphragm of the photographing lens 16 and electronic shutter speed and the like of the monochrome sensor 56.

The digital camera 245 also comprises a multiband image memory 52, a corresponding position designation portion 241 and a camera shake correction portion 161 for correcting displacement of the multiband image on the basis of camera shake information of a camera shake sensor 243. The observed position designation portion 241 detects the corresponding position of the observed portion 15 (affected portion) of the subject 14 from the image photographed by the digital camera 245 and the multiband camera 50.

Next, operation of the embodiment configured as above will be described.

In order to photograph the subject 14, the photographing lens 16 of the video camera is directed to the subject 14, and the field angle, the photographing position are determined by the operation dial 8 and the like. When the shutter button, not shown, is pressed halfway by the operator, the AE, AF control operation of the digital camera 245 is started. The information by this control is transmitted to the multiband camera 50, and the focus position of the photographing lens 53 is set by the photographing control portion 60 to the subject distance according to the AF information. Also, according to the AE information, the shutter speed of the monochrome sensor 56 and the diaphragm value of the photographing lens 53 are set. In this setting, since different shutter speed values are set for the individual color filters 54a, 54b of the filter 54 to have an appropriate exposure, photographing with good SN is possible.

When the shutter button is fully pressed, the photographing is started, and the image signal photographed by the RGB color image pickup device 5 is stored in the RGB signal memory 19. Also, at the multiband camera 50, the filter 54 is rotated, and photographing is executed using the different filters 54a, 54b. The displacement of the multiband image is corrected by the displacement correction portion 161 based on camera shake information from the camera shake sensor 243 and the displacement-corrected image is sequentially stored in the multiband image memory 52.

Next, using the operation dial 8, the position of the subject affected portion included in the photographed RGB color image and the multiband image is designated. That is, the respective images are displayed on the image display portion 7, and a designation cursor is superimposed and displayed on the displayed image.

FIG. 27 is an explanatory view for explaining the operation dial 8. The operation dial 8 comprises, as shown in FIG. 27, arrow keys in the up, down, right and left and a central enter key, and the designation cursor is constituted to be moved vertically and horizontally on the display image in response to the operation of the arrow key. And the position of the affected portion is determined in correspondence to a position of the designation cursor on the image at the timing when the enter key is operated. Such designation operation is performed for the RGB color image and the multiband image, and the respective corresponding positions are acquired. The position corresponding to the RGB color image is represented by Cx1, Cy2, and the position corresponding to the multiband image by Cy1, Cy2.

The configuration of the color correction portion 244 is the same as in FIG. 23, and the color correction is executed by the same operation as that of the above embodiment.

In this embodiment, in this way, since the RGB image is corrected on the basis of the spectral data calculated from the multiband camera 50, color correction with extremely high accuracy is possible. Also, though the number of pixels is not particularly described in this embodiment, it can be 5 million pixels for the digital camera 245 and about 400 thousand pixels for the multiband camera 50, for example, considering the sensitivity and the like. In this case, color information with high accuracy can be obtained with the multiband camera 50, but sufficient resolution can not be gained. But an image with high resolution can be obtained in the digital camera 245. Thus, an image is obtained in which the image with high resolution of the digital camera 245 and the color information with high accuracy of the multiband camera 50 are merged, and an image with extremely high quality can be obtained.

Also, since the multiband camera 50 in this embodiment is a filter rotation type frame sequential method, displacement is generated between spectral images due to camera shake and the like, but the displacement between the spectral images is corrected on the basis of the camera shake information by the camera shake sensor and the like in the digital camera 245, and the corresponding position can be obtained accurately.

In this embodiment, the rotating filter type multiband camera 50 as in FIG. 26 is used, but not limited to this, it is needless to say that a liquid crystal type wavelength variable filter or the like may be used.

Also, the observed position designation portion and the color correction portion are provided in the digital camera, but an arithmetic processing unit such as a personal computer, for example, other than the digital camera may be used. Moreover, in this embodiment, the multiband camera 50 is directly connected to the digital camera 245, but it may be provided separately and signal may be sent/received by wireless or the like.

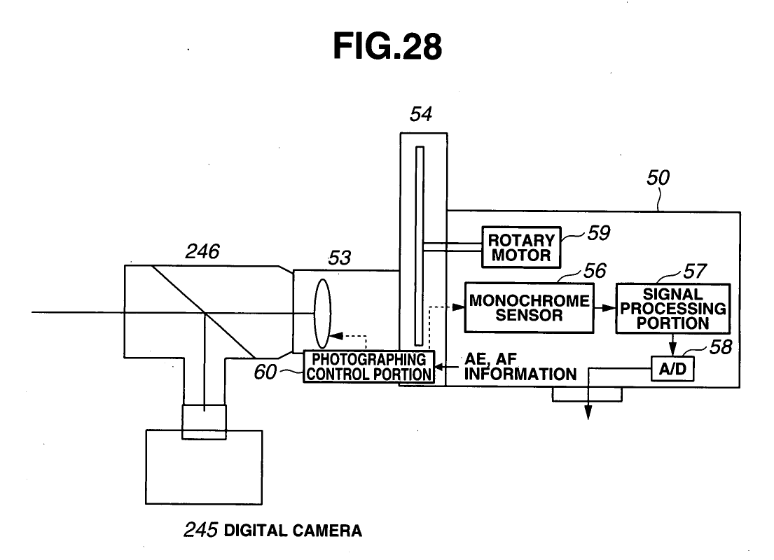

Also, as shown in FIG. 28, by providing optical path branching portion 246 so that the photographing directions and the field angles of the digital camera 245 and the multiband camera 50 are matched with each other, designation of the corresponding position becomes extremely easy.

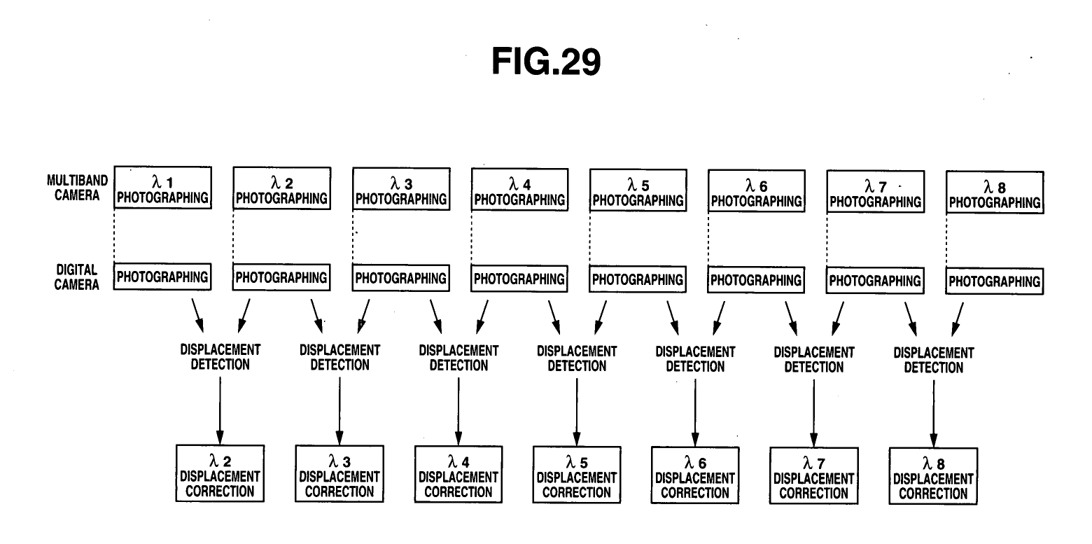

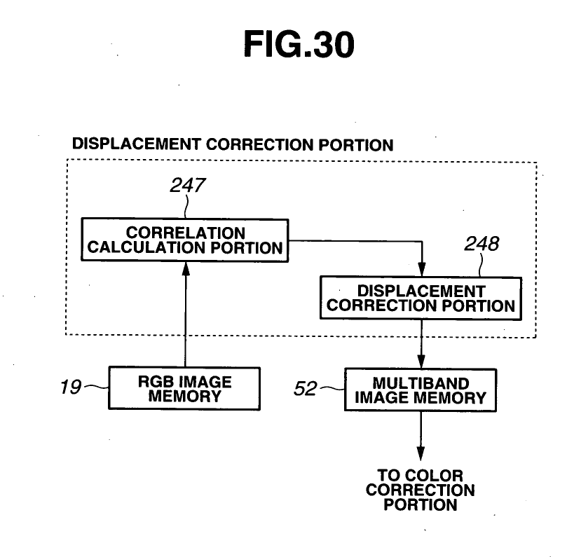

Also, the information of the camera shake sensor is used as the camera shake information, but an amount of displacement between images of the multiband image may be acquired for correction. Moreover, the image information photographed by the RGB color image may be used, and in this case, as shown in FIG. 29, the photographing timing of the respective spectral image of the multiband camera 50 and the photographing timing of the digital camera 245, for example, are matched with each other, a displacement is detected from consecutive 2 RGB images, and the spectral image can be corrected to the image position of λ1 using this information. A displacement amount between the RGB images is detected at a correlation calculation portion 247 as shown in FIG. 30, and on the basis of this, the position correction of the multiband image is executed at the displacement correction portion 248. The RGB image has higher resolution and higher position detection accuracy acquired as the result of correlation calculation than the case acquired from the multiband camera 50, and favorable shake correction is realized.

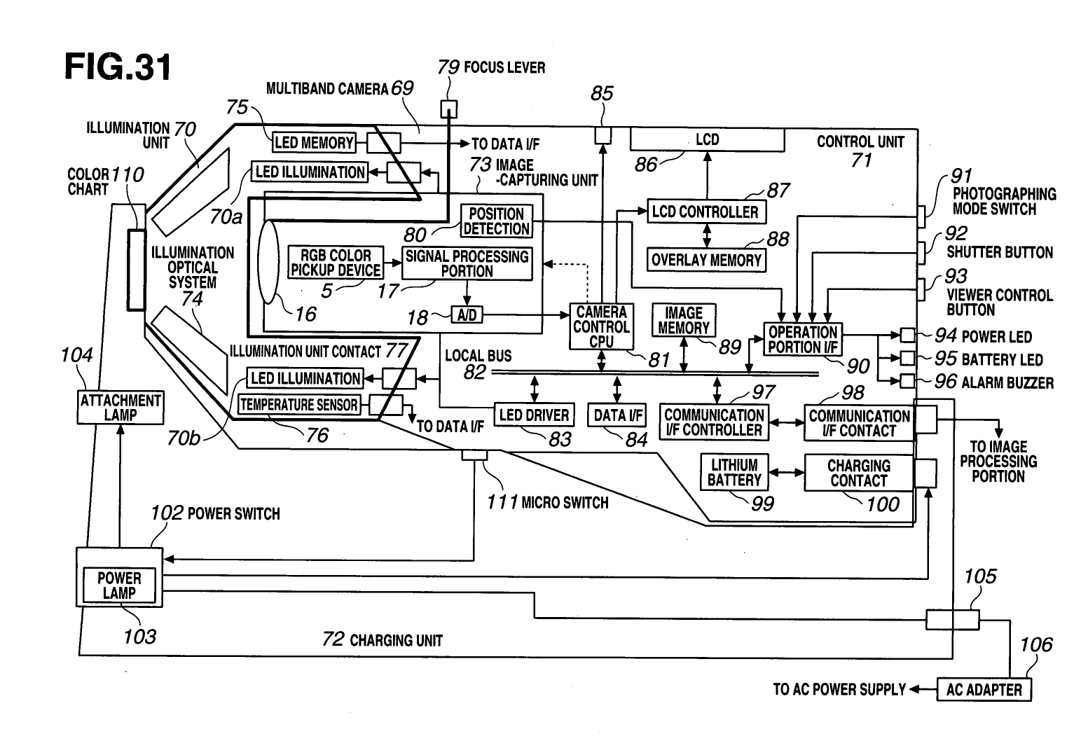

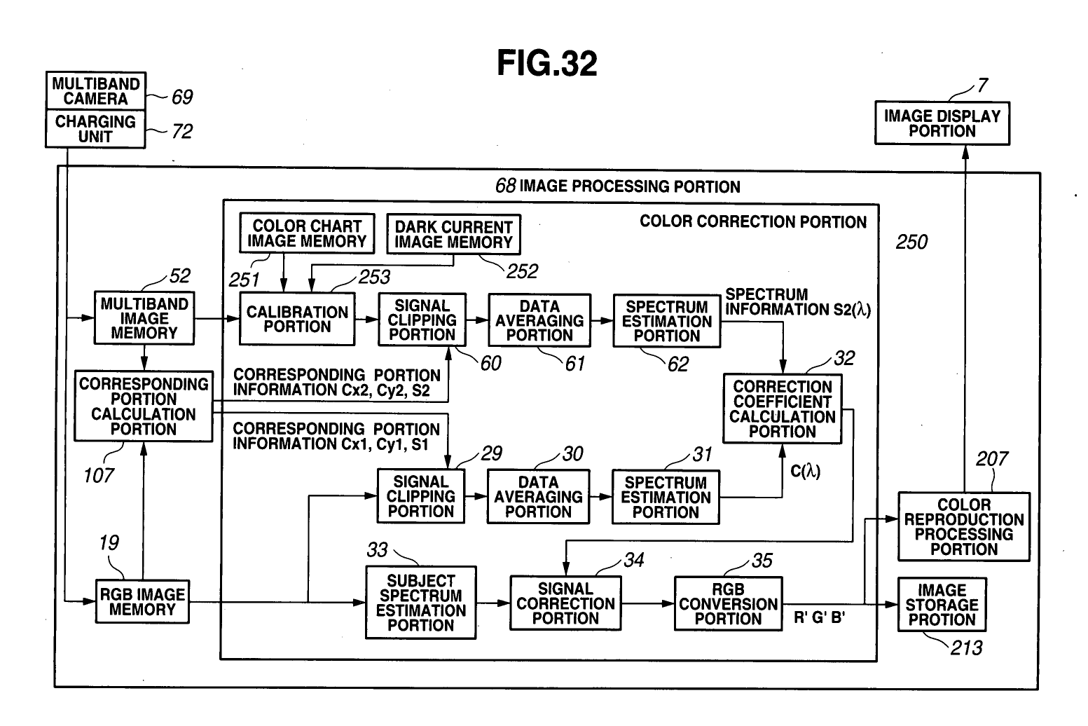

FIGS. 31 to 37 relates to a seventh embodiment of the present invention, and FIG. 31 is a block diagram showing a specific configuration of the camera side and FIG. 32 is a block diagram showing a specific circuit configuration of the image processing portion. In this embodiment, the present invention is applied to an illumination type multiband camera described in Japanese Patent Application No. 2002-218863 filed by the present applicant prior to the present invention, and this is preferable when a target to be photographed is a tooth or a face including teeth.

In FIG. 31, the photographing system comprises a multiband camera 69, a charging unit 72 and an image processing portion 68.

The multiband camera 69 further comprises an illumination unit 70, an image capturing unit 73 and a control unit 71. The illumination unit 70 shown by a bold line is detachably provided at the tip end side of the multiband camera 69, and sending/receiving of signals to/from the control unit 71, power supply and the like are executed by an illumination unit contact 77. Though not shown, it may be fixed instead of being detachably mounted.

The illumination unit 70 comprises an LED illumination portions 70a, 70b including a plurality of types of LED with different spectral characteristics of the emitted lights, an illumination optical system 74 for illuminating them to the subject, an LED memory 75 in which LED information is stored, and an temperature sensor 76 for measuring the temperature of the vicinity of the LED. The LED illumination portions 70a, 70b are constituted by twenty eight LEDs in total, in which four each of 7 types of LEDs are arranged in this embodiment, for example. The central wavelengths of the respective LED are 450 nm, 465 nm, 505 nm, 525 nm, 575 nm, 605 nm, 630 nm. Also, the illumination optical system 74 is to irradiate the subject face (the face of a color chart 110 on the camera side in FIG. 31) with the LED light and is constituted so that the LED light is emitted substantially uniformly.

The image capturing unit 73 comprises the photographing lens 16, the RGB color image pickup device 5, the signal processing portion 17 for analog processing such as gain correction and offset correction and the AD converter 18. A focus lever 79 is to change the focus manually and is provided with a contact 80 for detecting the position of the focus lever 79.

A camera control CPU 81 in the control unit 71 is a CPU for camera control and is connected to a local bus 82 and an LCD controller 87 as well as to a composite output terminal 85 for control of the image capturing unit 73 and output of a color image signal photographed by the image capturing unit 73 to an external monitor.

An LED driver 83 is to control light emission of the LED illumination portions 70a, 70b, and a data I/F 84 is an interface for receiving contents of the LED memory 75 of the illumination unit 70 and information of the temperature sensor 76. A communication I/F controller 97 is a controller for controlling a communication I/F such as an USB2, for example, and reference numeral 98 denotes a communication I/F connection contact for that connection.

A lithium battery 99 supplies power to the entire multiband camera 69 and is connected to a charging contact 100, which is a contact for charging. An image memory 89 is for temporary storage of image data photographed by the image capturing unit 73.

In this embodiment, the LED illumination portions 70a, 70b use 7 types of LED, and the image memory 89 has a capacity capable of storing at least 7 types of spectral images and 1 RGB color image. The LCD monitor 86 is a monitor for displaying an image being photographed by a camera or a photographed image.

Also, the LCD monitor 86 is configured so that an image superimposed with an image pattern stored in an overlay memory 88 is displayed as necessary. Such image patterns include a horizontal line for photographing the entire teeth horizontally or a cross line crossing it, for example. An operation portion I/F 90 sends/receives a signal to/from an operation button disposed at the multiband camera 69 and an output portion, not shown, for information transmission.

Operation buttons include a photographing mode switch 91 for switching between the normal RGB photographing and the multiband photographing, a shutter button 92, a viewer control button 93 for operating change of image data displayed on the LCD monitor 86 and the like. A power LED 94 functions as an output portion for the information transmission and notifies the state of the multiband camera 69 to the operator. Also, a battery LED 95 for notifying the state of the battery, an alarm buzzer 96 for alarming a danger at photographing and the like are configured on the back face side of the multiband camera 69.

The relation between lighting of these LED 94 to 96 and each operation state is as follows, for example.

Power LED

Green lighted: Photographing ready

Green flashing: During photographing preparation (initial warming and the like)

Red lighted/extinguished: Battery being charged

Battery LED

Green lighted: Sufficient battery capacity

Amber lighted: Battery capacity is small (requiring charging)

Red lighted: Battery capacity is extremely small (requiring immediate charging)

Alarm buzzer

Alarm: Photographed image data is invalid

The charging unit 72 comprises a color chart 110 for calibration of the multiband camera 69, a micro switch 111 for checking if the multiband camera 69 has been attached at a normal position of the charging unit 72, a power switch 102 for turning ON/OFF of the power supply of the charging unit, a power lamp 103 for lighting/extinguishing in conjunction with ON/OFF of the power switch 102, and an attachment lamp 104 lighted when the multiband camera 69 has been attached at a normal position.

The charging unit 72 is a desktop type, for example, and when the multiband camera 69 is attached at a predetermined position of the charging unit 72, power can be supplied to the multiband camera 69 through the charging contact 100 of the multiband camera 69.

The attachment lamp 104 is lighted in green when the charging unit 72 is attached at the normal position of the multiband camera 69 and flashes in red when not. Also, to this charging unit 72, a power connector 105 is provided so that an AC adapter 106 is connected. And when the charged capacity of the lithium battery 99 is decreased and the battery LED 95 is flashed in amber or red, the lithium battery 99 is charged when the multiband camera 69 is placed in the charging unit 72.

The image processing portion 68 has, as shown in FIG. 32, a color correction portion 250 in the substantially same configuration as the color correction portion 244 in FIG. 23. In this embodiment, the image processing portion 68 is provided with a corresponding position calculation portion 107. In each of the above embodiments, a corresponding point (corresponding position) is detected by manual operation, but in this embodiment, the corresponding point is detected fully automatically.

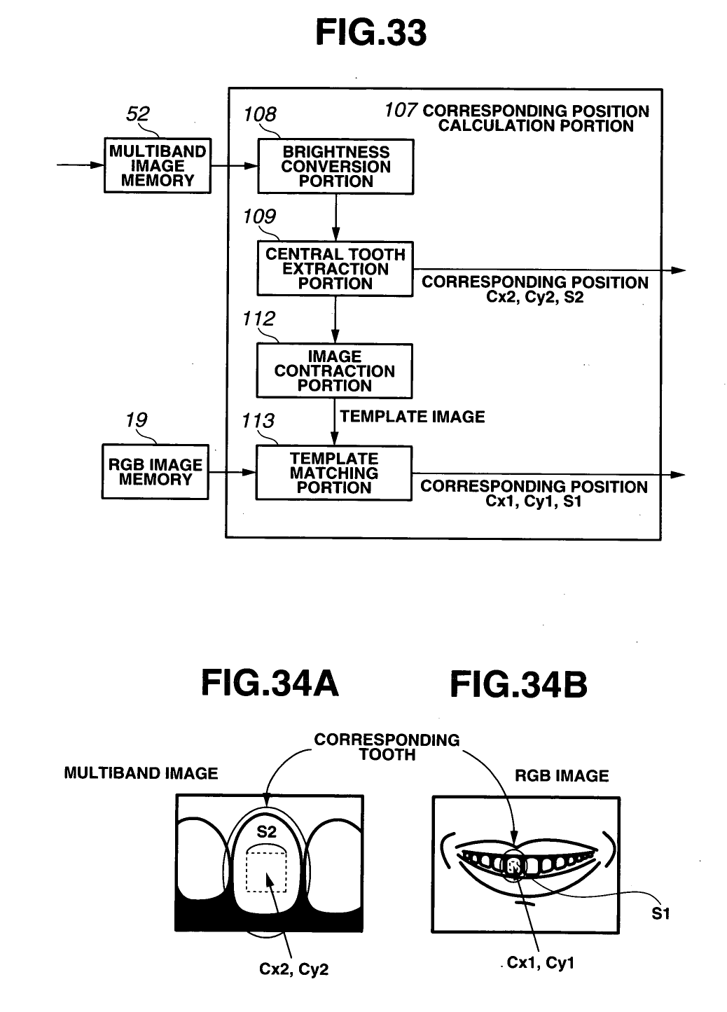

FIG. 33 is a block diagram showing a specific configuration of the corresponding position calculation portion 107 in FIG. 32. Also, FIGS. 34A and 34B are explanatory views showing an input image of the corresponding position calculation portion 107, in which FIG. 34A shows a multiband image and FIG. 34B for an RGB image.

As shown in FIG. 33, the corresponding position calculation portion 107 comprises a brightness conversion portion 108 for taking out a brightness signal from the multiband image in FIG. 34A, a central tooth detection portion 109 for extracting an area of a tooth located substantially at the center of the screen, an image contraction portion 112 for contracting an image of the extracted central tooth, and a template matching portion 113 for detecting the corresponding position of the extracted tooth on the RGB color image.

As shown in FIG. 32, the image processing portion 68 has, in addition to the corresponding position calculation portion 107, a multiband image memory 52, an RGB image memory 19, a color correction portion 250, a color reproduction processing portion 207 to which an R′G′B′ image signal from the color correction portion 250 is given, and an image storage portion 213. The respective functions are the same as those of each of the above embodiments. The calibration portion 253 in the color correction potion 250 performs calibration of the multiband image using a color chart image stored in the color chart image memory 251 and a dark current image stored in a dark current image memory 252.

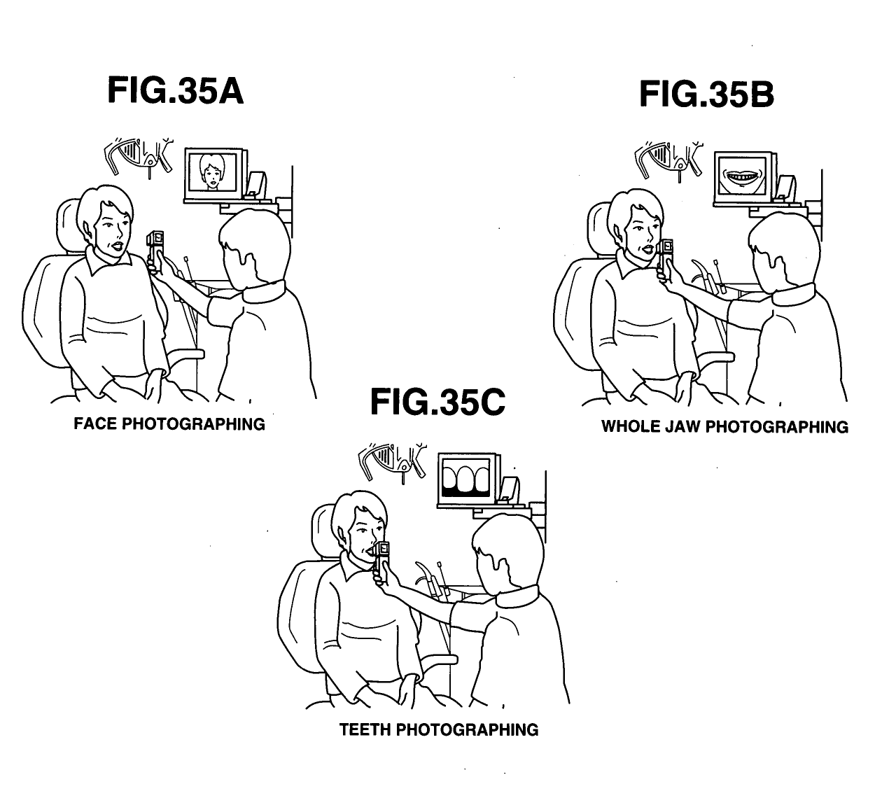

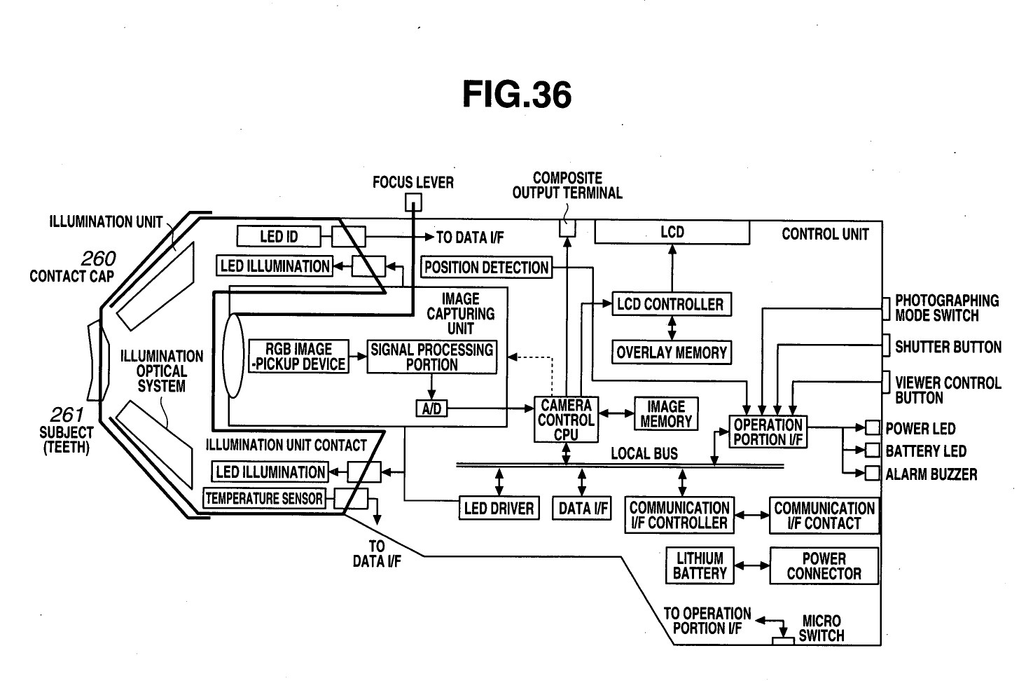

Next, action of the embodiment configured as above will be described referring to FIGS. 35A to 35C and FIG. 36.

In this embodiment, three photographing modes are provided. Each photographing mode will be described referring to FIGS. 35A to 35C. In this embodiment, whitening bleaching and denture configuration at a dental clinic are used as an example.

As the photographing modes, there are three types: a face photographing, which captures the whole face, as shown in FIG. 35A, a whole jaw photographing, which captures the whole upper and lower teeth as shown in FIG. 35B, and a teeth photographing which captures 1 or 2 teeth as shown in FIG. 35C. The face photographing and the whole jaw photographing are photographing as the RGB image and the teeth photographing is photographing as the multiband image. In this embodiment, the color of the RGB image obtained from the face photographing and the whole jaw photographing is corrected from the multiband image obtained from the teeth photographing.

(RGB Photographing)

The operator lifts up the multiband camera 69 and removes it from the charging unit 72 and sets the photographing mode to the “RGB mode”. The RGB color image pickup device 5 sequentially takes photos and the image is displayed on the LCD monitor 86. At this photographing, the LED illumination portions 70a, 70b are turned off. The operator (dentist or dental hygienist) aligns the position to the subject (face or jaw) while watching the image on the LCD monitor 86 and brings it into focus using the focus lever 79. At this time, the electronic shutter speed of the RGB color image pickup device 5 is controlled by the camera control CPU 81 so as to obtain appropriate exposure. And the image taken when the shutter button is pressed is stored in the image memory 89. At this time, incidental information such as RGB image mode and the like is also stored.

Next, the operator places the multiband camera 69 on the charging unit 72. Then, the attachment lamp 104 is lighted, the captured RGB image is transferred to the RGB image memory 19 of the image processing portion 68 and stored therein.

(Multiband Photographing)

Next, the operator lifts up the multiband camera 69, removes it from the charging unit 72 and sets the photographing mode to the “calorimetric mode”. By this, at the LED illumination portions 70a, 70b, all the 7 types of LEDs are lighted, and the RGB image pickup device 5 sequentially takes photos and the images are displayed on the LCD monitor 86. Moreover, a contact cap 260 (See FIG. 36) is mounted to the illumination unit 70, and the operator (dentist or dental hygienist) aligns the position to a specific tooth while watching the image on the LCD monitor 86 and brings it into focus using the focus lever 79.

In this case, as shown in FIG. 36, the contact cap 260 is brought into contact with a tooth 261 to be photographed, and the position is fixed to some extent. And when desired positioning is performed, the shutter button is pressed by the operator and the multiband photographing is carried out. In this example, at the LED illumination portions 70a, 70b, the 7 types of LED are sequentially lighted, and a predetermined single-color image data in RGB images captured at each lighting is stored in the image memory 89.

450 nm (λ1)→B image

465 nm (λ2)→B image

505 nm (λ3)→G image

525 nm (λ4)→G image

575 nm (λ5)→G image

605 nm (λ6)→R image

630 nm (λ7)→R image

In this case, an image of the color selected from the RGB image corresponding to the center wavelength of the LED as above is stored as a multiband image in the image memory 89. Also, the LED illuminating time, illumination intensity, electronic shutter speed of the image capturing device and the like are controlled by the camera control CPU 81 so that the photographing at each wavelength has appropriate exposure at the photographing. Moreover, if temperature change is severe at this photographing, an alarm buzzer is sounded to issue an alarm.

When the photographing is finished, the contact cap is removed and then, when the multiband camera 69 is placed on the charging unit 72, the attachment lamp 104 is lighted, and the calibration image is measured. At this time, it is so configured that the multiband camera 69 can not be placed on the charging unit 72 if the contact cap is not removed. That is, the LED with the same wavelength as that of the LED used for the photographing is sequentially lighted to photograph the color chart 110, and the photographed image is stored in the image memory 89 as a color chart image. Then, photographing is carried out in the state where no LED is lighted (in the dark), and it is stored in the image memory 89 as a dark current image.

Next, the photographed multiband image, the color chart image and the dark current image are transferred to the image processing portion 68, and the color chart image and the dark current image are stored in the color-chart image memory 251 or a dark current image memory 252, respectively. The subject image is stored in the multiband image memory 52. The calibration portion 253 carries out the following calculation:
M′(λ)=(M(λ)−D(λ))/W(λ)

M(λ):Subject image

D(λ):Dark current image

W(λ):Color chart image

M′(λ):Calibrated subject image

And the dark current of the RGB color image pickup device 5 and the light amount deterioration, wavelength shift and the like of the LED illumination portions 70a, 70b are corrected. Particularly, since the light emitting amount of the LED is changed according to the temperature change, it is extremely effective for accuracy improvement to perform calibration according to at the time of the operation. The action after the calibration processing is the same as that of the above embodiment. In this way, color correction with high accuracy can be performed for the RGB image.

In this embodiment, since the corresponding positions of the multiband image and the RGB image are automatically calculated, cumbersome operation such as manual designation of the corresponding position is not needed any more. Also, the multiband camera 69 can be operated by the battery in the cableless manner, and its convenience is remarkably improved. Moreover, correction is made using a color chart, so that deterioration, variation of the LED and the image capturing device can be corrected and colorimetry with extremely high accuracy can be realized.

The color chart 110 is built in a cradle also having a charging function, and the user needs not perform cumbersome operation for calibration. Moreover, by lighting of the attachment lamp, operation errors at transfer of the image data can be reduced, and secure data transfer is enabled. Furthermore, the state of charging can be grasped all the time by the battery lamp of the main body. And the temperature sensor is provided, and when temperature is changed at the tooth photographing or a temperature difference is large between the teeth photographing and at calibration and the like, an alarm is issued using an alarm buzzer, which makes stable photographing possible.

The image processing portion can be constituted by a usual personal computer or the like, and in this case, it is obvious that the color correction portion may be realized by software.

Also, if the main body has been removed from the charging unit 72 and not returned to the charging unit 72 for some time after measurement, there is a possibility that the user has forgotten, and an alarm may be issued by sounding an alarm buzzer or the like.

Also, the color chart is expected to be deteriorated over time. Particularly, there is a concern of influence by light, stain due to dust and the like. As means to prevent this, a shutter may be provided between the color chart and the illumination unit and it is so configured that the shutter is closed to prevent external light and rubbish from entering when the multiband camera is raised.

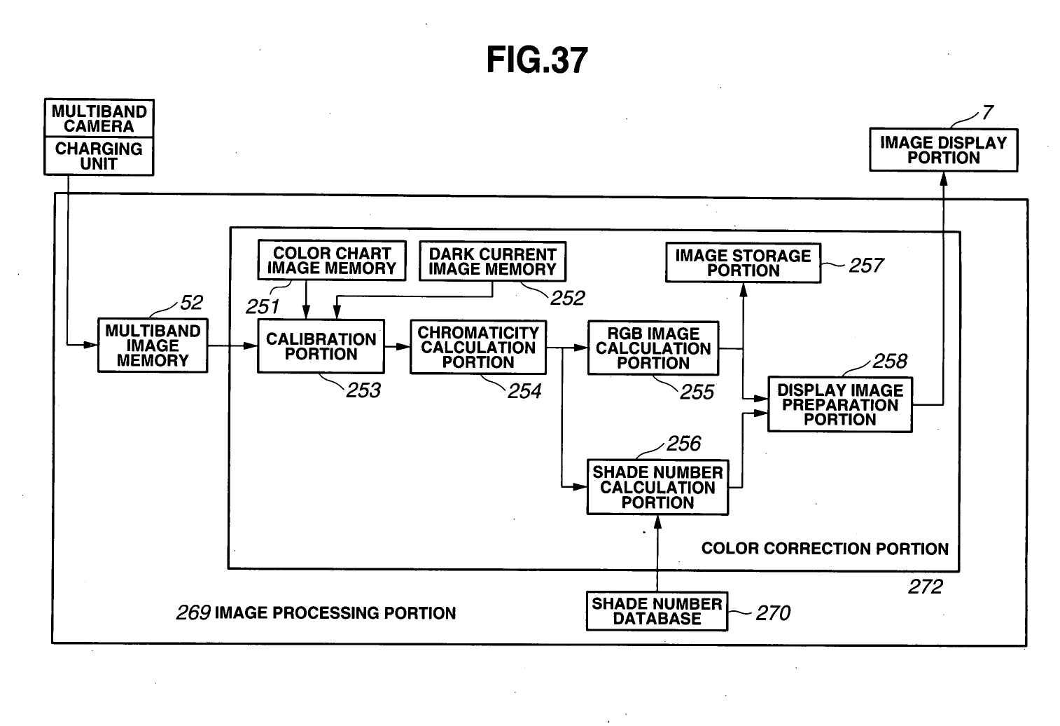

FIG. 37 is a block diagram showing another applied example using the image processing portion 269 using a colorimetric image as an image processing unit.

Reference numeral 254 denotes a chromaticity calculator for acquiring XYZ values of each image position from the calibrated subject image, and reference numeral 256 denotes a shade number calculator for calculating the shade number, which is a number of a dental-crown color chart, from the acquired XYZ values. The shade number calculator 256 acquires the shade number by comparing the acquired XYZ values and XYZ values of a shade guide of each company stored in a shade number database 270. Reference numeral 255 denotes an RGB image calculation portion for acquiring RGB image data and reference numeral 257 denotes a storage portion therefor. Reference numeral 258 is a corrected image creation portion for correcting color variation of the image display portion 7, and the color-corrected image is displayed on the image display portion 7. By the color correction portion 272 configured as above, the shade number of the tooth is accurately determined from the multiband image and accurate colors of the tooth are displayed on the image display portion 7.

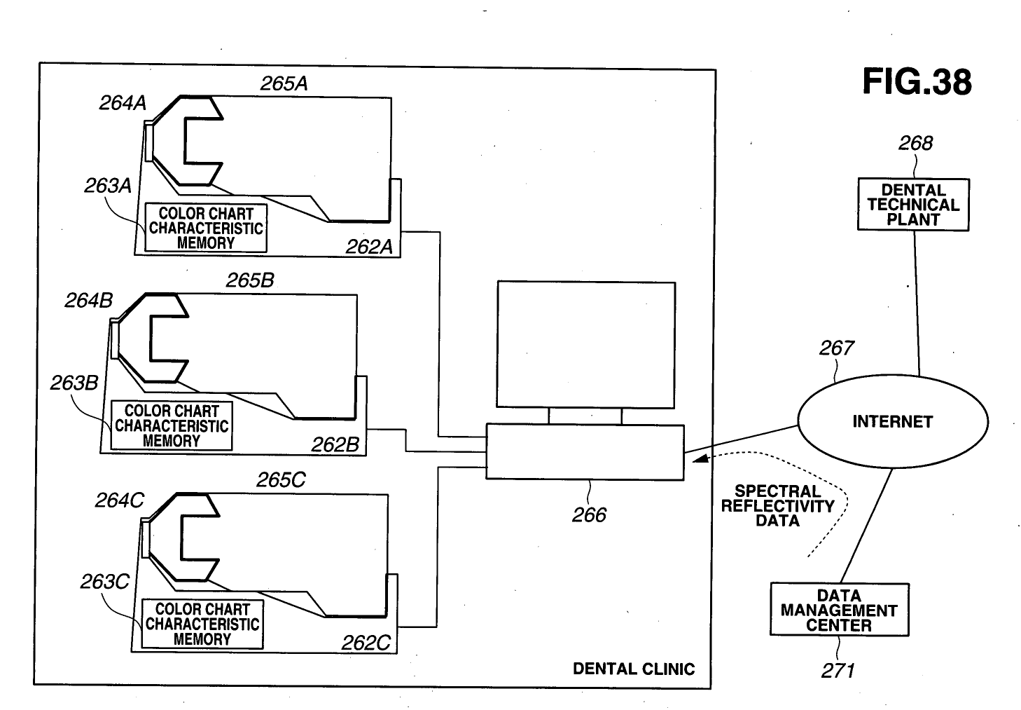

FIG. 38 is an explanatory view showing an eighth embodiment of the present invention.

As mentioned above, the color charts are deteriorated by various factors. Also, actual color charts have some extent of variation from the beginning. When it is to be used at a dental clinic, there is no problem with a single system, but as in FIG. 36, in the case of three sets of the photographing system, it is not known which multiband camera is combined with the charging unit in use. Particularly, since calibration is made on the basis of the color chart data, if the color chart itself is varied, different measurement results would be obtained for each multiband camera even if the same tooth is measured. Then, in this embodiment, a color-chart characteristic memory storing the spectral reflectivity of the color chart is provided in each charging unit so that further correction is made using this spectral reflectivity at calibration.

In FIG. 38, in a dental clinic, photographing systems 264A to 264C which are the same as that of the seventh embodiment are provided. The photographing systems 264A to 264C are provided with multiband cameras 265A to 265C in the same configuration as that of the multiband camera 69, respectively, and charging units 262A to 262C in the same configuration as that of the charging unit 72. Moreover, at the charging units 262A to 262C, color-chart characteristic memories 263A to 263C are provided, respectively.

In an example in FIG. 38, the multiband cameras 265A to 265C are connected to a microcomputer 266 constituting a common image processing portion for these three photographing systems 264A to 264C. Moreover, the microcomputer 266 is connected to a microcomputer, not shown, at a dental workshop 268 through the Internet 267 and also to a microcomputer, not shown, of a data management center 271 through the Internet 267.

In the calibration process by the microcomputer 266, the following calculation is executed to correct variation in each color chart:
M′(λ)=(M(λ)−D(λ))/W(λ)*S(λ)

M(λ):Subject image

D(λ):Dark current image

W(λ):Color chart image

S(λ):Spectral reflectivity of color chart

M′(λ):Calibrated subject image

By this, camera compatibility between a plurality of systems is realized. Also, this correction is also effective at exchange of data between a dental clinic and a dental workshop, for example.

Also, it is effective to keep color charts capable of replacement when they are stained or discolored due to some reason. In replacing the color chart, a color chart is sent by mail from the data management center 271 to the dental clinic. And the dental clinic replaces the color chart. An ID number is put on the color chart, and it may be so constituted that the spectral reflectivity data of the color chart according to the number is automatically transferred from the data management center 271 to the dental clinic (broken line in FIG. 32) and written in the color-chart characteristic memories 263A to 263C of the respective charging units 262A to 262C.

Also, though not shown, an identification code is provided on the color chart so that the ID number may be automatically recognized by the charging unit. It is needless to say that a barcode method, a wireless tag method and the like may be used as means.

By updating data online, the users do not have to perform a cumbersome operation, which improves convenience. When the color chart is required to be replaced, an alarm message may be issued automatically according to time from installation, displacement of signal value from the installation and the like. Also, this alarm may be notified to the data management center 261 through the Internet so that the data management center 271 can contact the user via phone or the like referring to this notification information to prompt replacement of the color chart, which enables stable colorimetry all the time.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A photographing system for photographing a subject comprising:
color information detecting portion configured to detect color information of the subject;
color image capturing portion configured to capture a color image of the subject; and
color correcting portion configured to execute color correction of a color image photographed by the color image capturing portion from corresponding position information of the color information detecting portion and the color image capturing portion.

2. The photographing system according to claim 1, wherein the color information detecting portion obtains more spectrum information than the color image capturing portion.

3. The photographing system according to claim 1, wherein the color information detecting portion comprises a spectrocolorimeter for detecting spectrum information.

4. The photographing system according to claim 1, wherein the color information detecting portion comprises a calorimeter for detecting chromaticity information.

5. The photographing system according to claim 1, wherein the color information detecting portion has a mounting portion enabling mounting to the color image capturing portion.

6. The photographing system according to claim 5, wherein data is sent/received between the color information detecting portion and the color image capturing portion through the mounting portion.

7. The photographing system according to claim 1, wherein the color information detecting portion is constituted so that the measuring direction is made variable manually or by control from the color image capturing portion.

8. The photographing system according to claim 1, wherein the color image capturing portion is provided with image display portion so that the measuring direction of the color information detecting portion can be displayed on the image display portion.

9. The photographing system according to claim 1, wherein the color information detecting portion is provided with an active type measurement position designating portion.

10. The photographing system according to claim 3, wherein the color information detecting portion is configured to detect spectrum information of the subject and also detect illumination spectrum information around the color image capturing portion.

11. The photographing system according to claim 1, wherein the color information detecting portion is configured separately from the color image capturing portion, and respective signals are sent/received by wire or wireless.

12. The photographing system according to claim 1, wherein measurement by the color information detecting portion and photographing by the color image capturing portion are constituted to be executed substantially at the same time.

13. The photographing system according to claim 1, wherein the color information detecting portion is built in the color image capturing portion.

14. The photographing system according to claim 13, wherein the color image capturing portion has a half mirror and configured so that one of light fluxes is guided to the color information detecting portion.

15. The photographing system according to claim 1, wherein the color information detecting portion is configured by a multi-spectral camera capable of obtaining a spectral image of 4 bands or more.

16. The photographing system according to claim 15, wherein the multi-spectral camera is provided with a plurality of spectral filters and is configured to be capable of changing the spectral filters manually or by control from the color image capturing portion.

17. The photographing system according to claim 16, wherein the multi-spectral camera is configured to be capable of photographing in a through state without the spectral fitter interposed.

18. The photographing system according to claim 16, wherein the spectral filter comprises an interference filter or a wavelength variable filter.

19. The photographing system according to claim 15, wherein the multi-spectral camera is constituted so that photographing is carried out in conjunction with the color image capturing portion and a photographing condition is set using photographing information of the color image capturing portion.

20. The photographing system according to claim 15, wherein the position of an image of each band photographed by the multi-spectral camera is corrected on the basis of image information photographed by the color image capturing portion.

21. The photographing system according to claim 1, wherein the color information detecting portion and the color image capturing portion use the same optical system and image capturing device.

22. The photographing system according to claim 21, further comprising mode changing portion configured to switch between detection of color information and capturing of a color image.

23. The photographing system according to claim 22, wherein mode change by the mode changing portion is automatically executed from focus information of the color image capturing portion.

24. The photographing system according to claim 21, further comprising calibration portion configured to calibrate a detection result of the color information detecting portion on the basis of an image capturing result of a color chart.

25. The photographing system according to claim 21, further comprising a corresponding position detection portion for automatically detecting a corresponding position of an image photographed by the color information detecting portion and an image photographed by the color image capturing portion.

26. A photographing system comprising:
a multi-spectral camera portion capable of photographing of both a multiband image and a color image;
a charging unit for charging the multi-spectral camera portion; and
an image processing portion which processes an image signal of the multi-spectral camera portion.

27. The photographing system according to claim 26, wherein the multi-spectral camera portion is provided with a control unit and an illumination unit; and
the illumination unit is capable of detachment.

28. The photographing system according to claim 26, wherein the multi-spectral camera portion is provided with an image display portion.

29. The photographing system according to claim 27, wherein the illumination unit is provided with a light source with different spectral characteristics of 4 colors or more and illumination light of the four colors or more is sequentially or simultaneously irradiated at photographing of the multiband image.

30. The photographing system according to claim 26, wherein the multi-spectral camera portion is provided with a photographing mode switching portion, and the photographing mode switching portion switches between the multiband image and the color image.

31. The photographing system according to claim 26, wherein the charging unit is provided with a color chart used for calibration of the multiband image.

32. The photographing system according to claim 31, wherein the image processing portion further comprises calibration portion configured to calibrate the multiband image on the basis of a photographing result of the color chart.

33. The photographing system according to claim 31, wherein the charging unit further comprises a characteristic data storage portion for storing characteristic data corresponding to the color chart.

34. The photographing system according to claim 33, wherein the characteristic data storage portion has characteristic data corresponding to ID number given to the color chart inputted from outside through a predetermined communication line.

35. The photographing system according to claim 31, further comprising detecting portion configured to detect deterioration of the color chart; and
outputting portion configured to output a detection result by the detecting portion.

36. The photographing system according to claim 26, wherein the charging unit and the multi-spectral camera portion are provided with a contact for sending/receiving data to each other.

37. The photographing system according to claim 26, wherein the charging unit is provided with a lamp for checking attachment of the multi-spectral camera portion, and the lamp for checking attachment of the multi-spectral camera portion is lighted when the multi-spectral camera portion is attached at a normal position of the charging unit.

38. The photographing system according to claim 26, wherein the charging unit is provided with data transfer portion, and
the data transfer portion automatically transfers data from the multi-spectral camera portion to the image processing portion when the multi-spectral camera portion is attached at a normal position of the charging unit.

39. The photographing system according to claim 26, wherein the image processing portion further comprises an information storage portion for storing information relating to a shade number; and
a shade number determining portion for determining the shade number from the multiband image on the basis of information stored in the information storage portion.

40. The photographing system according to claim 26, wherein the multi-spectral camera portion performs color image photographing for face photographing or whole jaw photographing and multiband photographing for tooth photographing.

41. The photographing system according to claim 40, wherein the image processing portion performs color correction of the face image or the whole jaw photographing on the basis of the tooth image obtained by the multiband photographing.

42. A photographing system for photographing a subject comprising:
color information detecting means for detecting color information of the subject;
color image capturing means for capturing a color image of the subject; and
color correcting means for executing color correction of a color image photographed by the color image capturing means from corresponding position information of the color information detecting means and the color image capturing-means.
